(19) United States
(12) Patent Application Publication
(10) Pub. No.: US 2026/0369872 A1
(43) Pub. Date: Nov. 19, 2026

(54) WEARABLE DEVICE

(71) Applicant: HONOR DEVICE CO., LTD., Shenzhen (CN)

(72) Inventors: Xiaotao Cai, Shenzhen (CN); DAWEI ZHOU, Shenzhen (CN); Zhenhua Cao, Shenzhen (CN)

(21) Appl. No.: 19/703,907

(22) Filed: Jun. 10, 2026

Related U.S. Application Data
(63) Continuation of application No. PCT/CN2024/106360, filed on Jul. 19, 2024.

(30) Foreign Application Priority Data
Dec. 21, 2023 (CN) 202311777425.9

(51) Int. Cl. H01Q 1/27; G04G 17/04; G04G 21/04

(52) U.S. Cl. CPC H01Q 1/273; G04G 17/04; G04G 21/04

(57) ABSTRACT

This application provides a wearable device, a display, a bottom housing, a first circuit board, and a first feed. The bottom housing includes a first conductor, where the first conductor includes a first feed point. The first circuit board is located between the first conductor and the display, where the first circuit board includes a first conductor layer. The first feed is disposed on the first circuit board, where the first feed is electrically connected to the first feed point. The first conductor is spaced apart from the first circuit board. The first feed is configured to excite a first antenna structure through the first feed point to generate a first electromagnetic wave signal. The first antenna structure includes at least the first conductor and the first conductor layer of the first circuit board.

### CROSS-REFERENCE TO RELATED APPLICATIONS

This application is a continuation of International Application No. PCT/CN2024/106360, filed on Jul. 19, 2024, which claims priority to Chinese Patent Application No. 202311777425.9, filed on Dec. 21, 2023, both of which are incorporated herein by reference in their entireties.

### TECHNICAL FIELD

This application relates to the field of electronic device technologies, and in particular, to a wearable device.

### BACKGROUND

As a screen-to-body ratio of an electronic device increases, a gap between a side frame and a screen is required to become narrower. However, this makes it more difficult for electromagnetic wave signals generated by exciting an antenna component including the screen to radiate outward from the gap between the side frame and the screen, degrading antenna performance. Therefore, how to design an antenna under the condition of a high screen-to-body ratio becomes very important.

In addition, because a human body is a dielectric, when a wearable device is positioned closer to the human body, the human body absorbs electromagnetic energy of the wearable device, degrading antenna performance of the wearable device. According to the boundary conditions for electromagnetic fields, because the human body is a dielectric with a high dielectric constant, a tangential electric field component with respect to a surface of the human body is more likely to enter the human body and be absorbed, while a normal electric field component with respect to the surface of the human body is less likely to enter the human body and be absorbed. Therefore, designing an antenna that exhibits normal electric field distribution with respect to the surface of the human body can reduce absorption by the human body, and the human body can even improve antenna performance. This can effectively resolve the problem of antenna performance degradation caused by absorption by the human body when the wearable device is worn on the human body.

### SUMMARY

In view of this, this application provides a wearable device, to reduce signal attenuation and therefore increase signal coverage.

This application provides a wearable device. The wearable device includes: a display, a bottom housing, a first circuit board, and a first feed. The bottom housing includes a first conductor, where the first conductor includes a first feed point. The first circuit board is located between the first conductor and the display, where the first circuit board includes a first conductor layer. The first feed is disposed on the first circuit board, where the first feed is electrically connected to the first feed point. The first conductor is spaced apart from the first circuit board. The first feed is configured to excite a first antenna structure through the first feed point, to generate a first electromagnetic wave signal. The first antenna structure includes at least the first conductor and the first conductor layer of the first circuit board. The bottom housing includes the first conductor, and an electromagnetic wave signal is not generated by exciting a metal layer on the display. Therefore, the electromagnetic wave signal does not need to be completely radiated outward through a gap beside the display. Instead, a gap for radiating the first electromagnetic wave signal may be provided between the display and the bottom housing. As a result, as a screen-to-body ratio increases, a size of the gap for radiating the first electromagnetic wave signal is not affected, and attenuation of the first electromagnetic wave signal is reduced, thereby enhancing radiation efficiency of the first electromagnetic wave signal.

In a possible implementation, at least a part of the first conductor is parallel to the first circuit board. When the wearable device is worn, the bottom housing is close to skin of a human body. The bottom housing includes the first conductor. The first antenna structure includes at least the first conductor and the first conductor layer of the first circuit board. The first feed is configured to excite the first antenna structure through the first feed point, to generate the first electromagnetic wave signal. At least the part of the first conductor is parallel to the first circuit board. Therefore, when the first feed excites the first antenna structure through the first feed point, to generate the first electromagnetic wave signal, the first antenna structure is excited to generate an electric field perpendicular to at least the part of the first conductor and the first circuit board. Because the first conductor is disposed on the bottom housing, the first conductor is also approximately parallel to the bottom housing. Therefore, when the wearable device is worn, the electric field generated by the first antenna structure is a normal electric field with respect to the human body, that is, the electric field is perpendicular to a skin surface of a human body part on which the wearable device is worn. The human body is unlikely to absorb the normal electric field, that is, is unlikely to absorb the electric fields perpendicular to the surface of the human body. Therefore, compared to generating a tangential electric field, generating the normal electric field can reduce the attenuation of the first electromagnetic wave signal, and increase coverage of the first electromagnetic wave signal.

In a possible implementation, the first antenna structure is a cavity antenna structure or a patch antenna structure. Because both the cavity antenna structure and the patch antenna structure can concentrate first electromagnetic wave signals, radiation directivity can be optimized and radiation efficiency can be enhanced.

In a possible implementation, a resonance frequency of the first antenna structure is determined based on at least a length of a long side and/or a length of a short side of the first conductor. As a result, the resonance frequency of the first antenna structure may be adjusted to a target resonance frequency by adjusting the length of the long side and/or the length of the short side of the first conductor.

In a possible implementation, the wearable device further includes: a second feed and a side frame, and the side frame includes a second conductor; the second conductor includes a second feed point, the side frame is disposed between the display and the bottom housing, and there is a gap between the second conductor and the first conductor; and the second feed is electrically connected to the second feed point, and the second feed is configured to excite the second conductor through the second feed point, to generate a second electromagnetic wave signal. As a result, a structure of the side frame of the wearable device can be fully utilized. The side frame has a support function, and the second feed can further excite the second conductor on the side frame to generate the second electromagnetic wave signal, thereby implementing a plurality of functions.

In a possible implementation, the gap between the second conductor and the first conductor is used for at least the first electromagnetic wave signal to radiate outward from the wearable device. As the screen-to-body ratio increases, a size of the gap between the second conductor and the first conductor does not need to be reduced. Therefore, the size of the gap between the second conductor and the first conductor may be appropriately set, to avoid the attenuation of the first electromagnetic wave signal due to a reduced size of the gap, thereby avoiding a reduction in the coverage of the first electromagnetic wave signal.

In a possible implementation, the first conductor is partially electrically connected to the first conductor layer of the first circuit board. When the wearable device is worn, the bottom housing is close to skin of a human body. The bottom housing includes the first conductor. There is the gap between the second conductor and the first conductor, and the gap between the second conductor and the first conductor is used for at least the first electromagnetic wave signal to radiate outward from the wearable device. However, in some scenarios, for example, when the wearable device is worn tightly on the human body, the wearable device is pressed against the human body, causing a part of the wearable device to be indented into the skin. As a result, a part that is of the gap between the second conductor and the first conductor and that corresponds to the part indented into the skin is blocked. Because the human body is a dielectric, the human body affects, by covering or blocking the gap, the electric field generated by the first antenna structure, and the first conductor is partially electrically connected to the first conductor layer of the first circuit board (directly short-circuited or connected through a lumped or distributed device with small impedance), to eliminate or reduce impact on the electric field generated by the first antenna structure caused by the human body blocking the gap. Therefore, when the part of the wearable device is indented into the skin, good radiation performance can still be ensured.

In a possible implementation, the first conductor is partially electrically connected to the second conductor (directly short-circuited or connected through a lumped or distributed device with small impedance). This is also equivalent to short-circuiting, thereby eliminating or reducing impact caused on the electric field generated by the first antenna structure by the human body blocking a gap. Therefore, when a part of the wearable device is indented into the skin, good radiation performance can still be ensured.

In a possible implementation, the bottom housing further includes a bottom housing body; and the first conductor is a metal sheet disposed in the bottom housing body; or the first conductor is a metal layer formed on an inner surface and/or an outer surface of the bottom housing body in a preparation process. Because the first antenna structure includes the first conductor, there is a corresponding special requirement for a shape and a structure of the first conductor, to improve radiation performance. The bottom housing includes the bottom housing body, and a structure of the bottom housing body allows for a more diversified design. Therefore, this can better adapt to an appearance design requirement of the wearable device.

In a possible implementation, the first feed point is provided in an edge region or a middle region of the first conductor. Because a mode in which the first feed point is provided in the edge region of the first conductor is different from a mode in which the first feed point is provided in the middle region of the first conductor, corresponding electromagnetic wave signals may be generated by the first antenna structure in different modes.

In a possible implementation, the wearable device further includes a third feed, the third feed is disposed on the first circuit board, the first conductor further includes a third feed point, the third feed point is spaced apart from the first feed point, and the third feed is connected to the third feed point, and is configured to excite the first antenna structure through the third feed point, to generate a third electromagnetic wave signal. As a result, the first antenna structure may be excited by using a plurality of feeds to generate corresponding electromagnetic wave signals.

In a possible implementation, the second feed is disposed on the first circuit board. Because various electronic components are conveniently disposed on the first circuit board, it is simple to dispose the second feed on the first circuit board.

In a possible implementation, an edge part that is of the first conductor layer of the first circuit board and that is close to the first feed point is electrically connected to the second conductor. The second feed is disposed on the first circuit board, and the second feed excites the second conductor through the second feed point, to generate a corresponding electric field. In some cases, the electric field affects the first electromagnetic wave signal generated by the first feed exciting the first antenna structure through the first feed point. Therefore, the edge part that is of the first conductor layer of the first circuit board and that is close to the first feed point is electrically connected to the second conductor, reducing this impact.

In a possible implementation, because the second feed is disposed on the first circuit board, the electric field generated by the second feed exciting the second conductor through the second feed point or a mode in which the second feed excites the second conductor through the second feed point directly exhibits high isolation from an electric field of the first electromagnetic wave signal generated by the first feed exciting the first antenna structure through the first feed point or a mode in which the first feed excites the first antenna structure through the first feed point to generate the first electromagnetic wave signal.

In a possible implementation, the wearable device further includes a fourth feed, the second conductor further includes a fourth feed point, the fourth feed point is spaced apart from the second feed point, the fourth feed is disposed on the first circuit board and is connected to the fourth feed point, and the fourth feed excites the second conductor through the fourth feed point, to generate a fourth electromagnetic wave signal. As a result, the first feed, the second feed, and the fourth feed may be disposed on the first circuit board, and the first feed excites the first antenna structure through the first feed point to generate the first electromagnetic wave signal. Both the second feed and the fourth feed generate corresponding electromagnetic wave signals by exciting the second conductor.

In a possible implementation, the wearable device further includes a second circuit board; the second circuit board is disposed between the first circuit board and the display; and the second feed is disposed on the first circuit board or the second circuit board. As a result, when the wearable device includes the first circuit board and the second circuit board, and the first feed is disposed on the first circuit board, the second feed may be disposed on the first circuit board or the second circuit board. Therefore, when the disposition is based on performance required by the wearable device and an arrangement requirement between components, the second feed disposed on the first circuit board or the second circuit board may be configured to excite the second conductor to generate a corresponding electromagnetic wave signal.

In a possible implementation, the second feed is disposed on the first circuit board, the wearable device further includes a fourth feed, the second conductor further includes a fourth feed point, the fourth feed is disposed on the second circuit board and is connected to the fourth feed point, and the fourth feed excites the second conductor through the fourth feed point, to generate a fourth electromagnetic wave signal. As a result, when the disposition is based on a dimension of the wearable device, a required frequency band, and an arrangement requirement between components, the wearable device may further support receiving and sending of a plurality of electromagnetic wave signals in the following manner: The first feed disposed on the first circuit board may excite the first antenna structure to generate the first electromagnetic wave signal, and the second feed disposed on the first circuit board may excite the second conductor to generate the second electromagnetic signal. The fourth feed disposed on the second circuit board may excite the second conductor to generate the fourth electromagnetic wave signal.

In a possible implementation, the wearable device further includes a fourth feed, the second conductor further includes a fourth feed point, the fourth feed is connected to the fourth feed point and is configured to excite the second conductor through the fourth feed point to generate a fourth electromagnetic wave signal, and both the second feed and the fourth feed are disposed on the second circuit board. As a result, when the disposition is based on a dimension of the wearable device, a required frequency band, and an arrangement requirement between components, the wearable device may further support receiving and sending of a plurality of electromagnetic wave signals in the following manner: The first feed disposed on the first circuit board may excite the first antenna structure to generate the first electromagnetic wave signal, and the second feed disposed on the second circuit board may excite the second conductor to generate the second electromagnetic signal. The fourth feed disposed on the second circuit board may excite the second conductor to generate the fourth electromagnetic wave signal.

In a possible implementation, the wearable device further includes a third conductor; the third conductor is disposed between the first circuit board and the second circuit board, and is spaced apart from the first circuit board and the second circuit board; a periphery of the third conductor is connected to an inner surface of the second conductor, or a periphery of the third conductor is spaced apart from an inner surface of the second conductor and the spacing is less than or equal to a preset distance; and the third conductor is configured to at least isolate an electromagnetic wave signal generated through excitation by a feed disposed on the first circuit board and an electromagnetic wave signal generated through excitation by a feed disposed on the second circuit board from each other. In this way, this can improve isolation between the electromagnetic wave signal generated by excitation of the feed on the first circuit board and the electromagnetic wave signal generated by excitation of the feed on the second circuit board.

In a possible implementation, at least a part of the third conductor is parallel to the second circuit board, the second circuit board includes a second conductor layer, the third conductor includes a fifth feed point, the wearable device further includes a fifth feed, the fifth feed is disposed on the second circuit board, the fifth feed excites the second antenna structure through the fifth feed point, to generate a fifth electromagnetic wave signal, and the second antenna structure includes at least the third conductor and the second conductor layer of the second circuit board. As a result, when the disposition is based on a dimension of the wearable device, a required frequency band, and an arrangement requirement between components, the wearable device may further support receiving and sending of a plurality of electromagnetic wave signals in the following manner: The fifth feed disposed on the second circuit board excites the second antenna structure to generate the fifth electromagnetic wave signal, where the second antenna structure includes at least the third conductor and the second conductor layer of the second circuit board.

In a possible implementation, positions of projections of the first feed point and the second feed point on the first circuit board are the same or different; the first electromagnetic wave signal and the second electromagnetic wave signal are signals among Wi-Fi signals, Bluetooth signals, GPS signals, and cellular signals; and the first electromagnetic wave signal and the second electromagnetic wave signal are the same or different. As a result, the wearable device can support a Wi-Fi signal, a Bluetooth signal, a GPS signal, and a cellular signal, which can be implemented by the first feed exciting the first antenna structure through the first feed point and/or the second feed exciting the second conductor through the second feed point, regardless of whether the positions of the projections of the first feed point and the second feed point on the first circuit board are the same or different.

In a possible implementation, positions of projections of the first feed point, the second feed point, and the third feed point on the first circuit board are different; connection lines between a center of the first circuit board and the positions of projections of the first feed point, the second feed point, and the third feed point on the first circuit board are on different radial lines; the first electromagnetic wave signal, the second electromagnetic wave signal, and the third electromagnetic wave signal are signals among Wi-Fi signals, Bluetooth signals, GPS signals, and cellular signals; and the first electromagnetic wave signal, the second electromagnetic wave signal, and the third electromagnetic wave signal are the same, or at least one of the first electromagnetic wave signal, the second electromagnetic wave signal, and the third electromagnetic wave signal is different.

In a possible implementation, positions of projections of the first feed point, the second feed point, and the fifth feed point on the first circuit board are different; connection lines between a center of the first circuit board and the positions of projections of the first feed point, the second feed point, and the fifth feed point on the first circuit board are on different radial lines; the first electromagnetic wave signal, the second electromagnetic wave signal, and the fifth electromagnetic wave signal are signals among Wi-Fi signals, Bluetooth signals, GPS signals, and cellular signals; and the first electromagnetic wave signal, the second electromagnetic wave signal, and the fifth electromagnetic wave signal are the same, or at least one of the first electromagnetic wave signal, the second electromagnetic wave signal, and the fifth electromagnetic wave signal is different. As a result, the wearable device can support a Wi-Fi signal, a Bluetooth signal, a GPS signal, and a cellular signal. Compared with the connection lines between the center of the first circuit board and positions of projections of at least two of the first feed point, the second feed point, and the fifth feed point on the first circuit board being on a same radial line, the connection lines between the center of the first circuit board and the positions of the projections of the first feed point, the second feed point, and the fifth feed point on the first circuit board being on the different radial lines can reduce mutual impact between the first electromagnetic wave signal, the second electromagnetic wave signal, and the fifth electromagnetic wave signal.

### DESCRIPTION OF DRAWINGS

To describe technical solutions in this application more clearly, the following briefly describes accompanying drawings used in describing implementations. Clearly, the accompanying drawings in the following descriptions are some implementations of this application, and a person of ordinary skill in the art may still derive other drawings from these accompanying drawings without creative efforts.

FIG. 1 is a diagram of a three-dimensional structure of a wearable device according to some embodiments of this application;

FIG. 2 is a diagram of a structure of a first possible wearable device according to an embodiment of this application;

FIG. 3 is a diagram of a structure of a second possible wearable device according to an embodiment of this application;

FIG. 4 is a diagram of a structure of a third possible wearable device according to an embodiment of this application;

FIG. 5 is a diagram of a structure of a possible side frame according to an embodiment of this application;

FIG. 6 is a sectional view in which a first conductor is electrically connected to a first conductor layer on a first circuit board according to an embodiment of this application;

FIG. 7 is a sectional view from 9 o'clock to 3 o'clock of a wearable device according to an embodiment of this application;

FIG. 8 is a sectional view in which a first conductor is partially electrically connected to a second conductor according to an embodiment of this application;

FIG. 9 is a diagram of a structure of a fourth possible wearable device according to an embodiment of this application;

FIG. 10 is a diagram of a structure of a fifth possible wearable device according to an embodiment of this application;

FIG. 11 is a diagram of a structure of a fifth possible wearable device according to an embodiment of this application;

FIG. 12 is a diagram of a structure of a sixth possible wearable device according to an embodiment of this application;

FIG. 13 is a diagram of a structure of a seventh possible wearable device according to an embodiment of this application;

FIG. 14 is a diagram of a structure of an eighth possible wearable device according to an embodiment of this application;

FIG. 15 is a diagram of a structure of a ninth possible wearable device according to an embodiment of this application;

FIG. 16 is a diagram of a structure of a tenth possible wearable device according to an embodiment of this application;

FIG. 17 is a diagram of a structure of an eleventh possible wearable device according to an embodiment of this application;

FIG. 18 is a diagram of a structure of a twelfth possible wearable device according to an embodiment of this application;

FIG. 19 is a diagram of a structure of a thirteenth possible wearable device according to an embodiment of this application;

FIG. 20 is a diagram of a structure of a fourteenth possible wearable device according to an embodiment of this application;

FIG. 21 is a diagram of a three-dimensional structure of FIG. 4 from a top view according to an embodiment of this application;

FIG. 22 is a diagram of a three-dimensional structure of FIG. 8 from a top view according to an embodiment of this application;

FIG. 23 is a diagram of a three-dimensional structure of FIG. 19 from a top view according to an embodiment of this application;

FIG. 24 is a simulation diagram of a return loss curve S1, a system radiation efficiency curve Sr1, and a total system efficiency curve St1 of a first antenna structure receiving and transmitting electromagnetic wave signals under excitation by a first feed according to an embodiment of this application;

FIG. 25 is a sectional view of electric field distribution present when a first feed excites a first antenna structure to operate at a first resonance frequency of 2.05 GHz according to an embodiment of this application;

FIG. 26 is an antenna radiation pattern present when a first feed excites a first antenna structure to operate at a first resonance frequency of 2.06 GHz according to an embodiment of this application;

FIG. 27 is a diagram of current distribution present when a first feed excites a first antenna structure to operate at a first resonance frequency of 2.05 GHz according to an embodiment of this application;

FIG. 28 is a sectional view of electric field distribution present when a first feed excites a first antenna structure to operate at a second resonance frequency of 2.5 GHz according to an embodiment of this application;

FIG. 29 is an antenna radiation pattern present when a first feed excites a first antenna structure to operate at a second resonance frequency of 2.5 GHz according to an embodiment of this application;

FIG. 30 is a diagram of current distribution present when a first feed V1 excites a first antenna structure to operate at a second resonance frequency of 2.5 GHz according to an embodiment of this application;

FIG. 31 is a simulation diagram of a return loss curve S2, a system radiation efficiency curve Sr2, and a total system efficiency curve St2 of a second feed according to an embodiment of this application;

FIG. 32 is a diagram of a first type of return loss curves and an isolation curve of a wearable device according to an embodiment of this application;

FIG. 33 is a simulation diagram of a system radiation efficiency curve Sr1 of a first feed and a system radiation efficiency curve Sr2 of a second feed in simulation of a wearable device being worn on an arm according to an embodiment of this application;

FIG. 34 is a diagram of a matching circuit according to an embodiment of this application;

FIG. 35 is a simulation diagram of a return loss curve S3, a system radiation efficiency curve Sr3, and a total system efficiency curve St3 present when a first feed excites a first antenna structure via a first matching circuit to generate a signal according to an embodiment of this application;

FIG. 36 is an antenna radiation pattern present when a first feed V1 excites a first antenna structure via a first matching circuit to generate a GPS signal according to an embodiment of this application;

FIG. 37 is a simulation diagram of a return loss curve S4, a system radiation efficiency curve Sr4, and a total system efficiency curve St4 present when a third feed excites a first antenna structure via a third matching circuit to generate a signal according to an embodiment of this application;

FIG. 38 is an antenna radiation pattern present when a third feed V3 excites a first antenna structure via a third matching circuit to generate a signal according to an embodiment of this application;

FIG. 39 is a simulation diagram of return loss curves S5 and S6 and efficiency curves Sr5 and Sr6 present when a second feed excites a second conductor via a second matching circuit to generate a signal according to an embodiment of this application;

FIG. 40 is a simulation diagram of return loss curves S7 and S8 and efficiency curves Sr7 and Sr8 present when a second feed excites a second conductor via a second matching circuit to generate a signal according to an embodiment of this application;

FIG. 41 is a simulation diagram of a return loss curve S9 and an efficiency curve Sr9 present when a second feed excites a second conductor via a second matching circuit to generate a signal according to an embodiment of this application;

FIG. 42 is a diagram of a second type of return loss curves and an isolation curve of a wearable device according to an embodiment of this application;

FIG. 43 is a diagram of a third type of return loss curves and an isolation curve of a wearable device according to an embodiment of this application;

FIG. 44 is a simulation diagram of a return loss curve of a third feed V3 exciting a first antenna structure via a third matching circuit to generate a GPS signal, when a second feed performs switching via a second matching circuit to generate cellular signals in frequency bands B1, B3, B5, and B8 according to an embodiment of this application; and

FIG. 45 is a simulation diagram of a return loss curve of a first feed exciting a first antenna structure via a first matching circuit to generate a Bluetooth signal, when a second feed performs switching via a second matching circuit to generate cellular signals in frequency bands B1, B3, B5, and B8 according to an embodiment of this application.

Reference numerals: wearable device 100; functional portion 101; wearing part 102; display 10; bottom housing 20; first circuit board 30; first feed V1; first conductor 21; first feed point F1; first conductor layer 31; first antenna structure A1; bottom housing body 22; second feed V2; side frame 40; second conductor 41; second feed point F2; gap D; fourth feed V4; fourth feed point F 4; second circuit board 50; third conductor 60; second conductor layer 51; fifth feed V5; fifth feed point F5; second antenna structure A2; battery E.

### DETAILED DESCRIPTION

The following describes embodiments of this application with reference to the accompanying drawings in embodiments of this application.

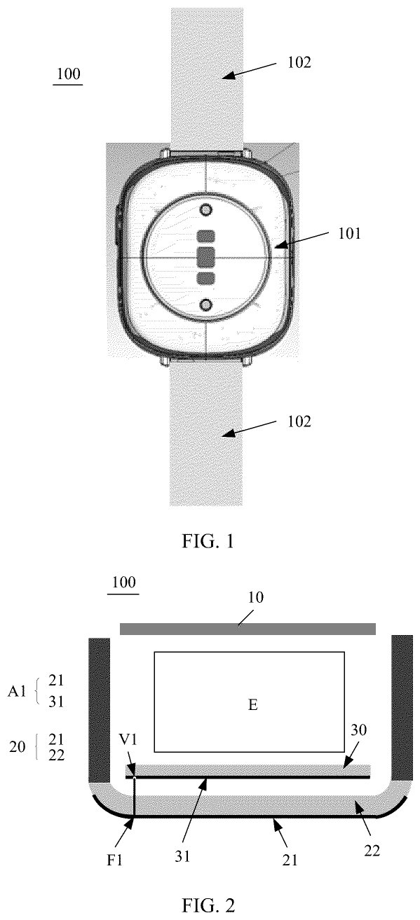

FIG. 1 is a diagram of a three-dimensional structure of a wearable device according to some embodiments of this application. The wearable device 100 may be, but is not limited to, a smart watch, a smart band, a smart ring, a smart necklace, or the like.

In some embodiments, as shown in FIG. 1, the wearable device 100 includes a functional portion 101 and a wearing part 102, and the wearing part 102 is connected to the functional portion 101. The wearing part 102 may be, but is not limited to, a watch strap, a waistband, a leg band, a headband, a chain, or the like. The functional portion 101 may be, but is not limited to, a watch body, wristband body, a functional component embedded in a ring, a pendant-like functional component in a necklace, or the like. The functional portion 101 has at least a communication function, and may further have one or more of the following functions: time display, weather display, image shooting, audio and video playing, sport monitoring, health monitoring, navigation, and the like.

As shown in FIG. 2, in some embodiments, the wearable device 100 includes a display 10, a bottom housing 20, a first circuit board 30, and a first feed V1. The bottom housing 20 includes a first conductor 21, where the first conductor 21 includes a first feed point F1. The first circuit board 30 is disposed between the first conductor 21 and the display 10, where the first circuit board 30 includes a first conductor layer 31. The first feed V1 is disposed on the first circuit board 30, where the first feed V1 is electrically connected to the first feed point F1. The first conductor 21 is spaced apart from the first circuit board 30. The first feed V1 is configured to excite a first antenna structure A1 through the first feed point F1, to generate a first electromagnetic wave signal. The first antenna structure A1 includes at least the first conductor 21 and the first conductor layer 31 of the first circuit board 30.

The bottom housing 20 includes the first conductor 21, and an electromagnetic wave signal is not generated by exciting a metal layer on the display. Therefore, the electromagnetic wave signal does not need to be radiated outward through a gap beside the display. Instead, a gap for radiating the first electromagnetic wave signal may be provided between the display 10 and the bottom housing 20. As a result, as a screen-to-body ratio increases, a size of the gap for radiating the first electromagnetic wave signal is not affected, and attenuation of the first electromagnetic wave signal is reduced, thereby enhancing radiation efficiency of the first electromagnetic wave signal.

Because a human body is a dielectric, when the wearable device 100 is positioned closer to the human body, the human body absorbs electromagnetic energy of the wearable device 100, degrading antenna performance of the wearable device 100. According to the boundary conditions for electromagnetic fields, because the human body is a dielectric with a high dielectric constant, a tangential electric field component with respect to a surface of the human body is more likely to enter the human body and be absorbed, while a normal electric field component with respect to the surface of the human body is less likely to enter the human body and be absorbed. Therefore, designing an antenna that exhibits normal electric field distribution with respect to the surface of the human body can reduce absorption by the human body, and the human body can even improve antenna performance. This can effectively resolve the problem of antenna performance degradation caused by absorption by the human body when the wearable device 100 is worn on the human body. In some embodiments, at least a part of the first conductor 21 is parallel to the first circuit board 30. That at least the part of the first conductor 21 is parallel to the first circuit board 30 means that at least a part of a surface that is of the first conductor 21 and that has a largest area is parallel to a surface that is of the first circuit board 30 and that has a largest area.

Parallel may be understood as substantially parallel, allowing for non-absolute parallelism due to factors such as an assembly tolerance, a design tolerance, and a structural flatness. An error within a small angle range is allowed. For example, a relationship with an assembly error range within 10 degrees may be understood as a parallel relationship.

In some embodiments, the first conductor layer 31 included in the first circuit board 30 is a structure at a specific layer of the first circuit board 30, and is parallel to the surface that is of the first circuit board 30 and that has the largest area. Therefore, the at least part of the first conductor 21 is parallel to the first circuit board 30, that is, the at least the part of the first conductor 21 is parallel to the first conductor layer 31 included in the first circuit board 30.

When the wearable device 100 is worn, the bottom housing 20 is close to skin of a human body. The bottom housing 20 includes the first conductor 21. The first antenna structure A1 includes at least the first conductor 21 and the first conductor layer 31 of the first circuit board 30. The first feed V1 is configured to excite the first antenna structure A1 through the first feed point F1, to generate the first electromagnetic wave signal. At least the part of the first conductor 21 is parallel to the first circuit board 30. Therefore, when the first feed V1 excites the first antenna structure A1 through the first feed point F1, to generate the first electromagnetic wave signal, the first antenna structure A1 is excited to generate an electric field perpendicular to at least the part of the first conductor 21 and the first circuit board 30. Because the first conductor 21 is disposed on the bottom housing 20, the first conductor 21 is also approximately parallel to the bottom housing 20. Therefore, when the wearable device 100 is worn, the electric field generated by the first antenna structure A1 is a normal electric field with respect to the human body, that is, the electric field is perpendicular to a skin surface of a human body part on which the wearable device 100 is worn. The human body is unlikely to absorb the normal electric field, that is, is unlikely to absorb the electric fields perpendicular to the surface of the human body. Therefore, compared to generating a tangential electric field, generating the normal electric field can reduce the attenuation of the first electromagnetic wave signal, and increase coverage of the first electromagnetic wave signal. As a result, antenna performance degradation caused by wearing on a human body is mitigated under the condition of an increasing screen-to-body ratio, thereby improving antenna performance of the wearable device when the wearable device is worn on the human body.

That is, in this application, the first antenna structure A1 includes at least the first conductor 21 and the first conductor layer 31 of the first circuit board 30 that are included in the bottom housing 20. A generated electric field is mainly an electric field perpendicular to the first conductor 21 and the first circuit board 30. Therefore, this can avoid absorption by the human body when the wearable device 100 is worn. This can effectively avoid absorption by the human body and ensure antenna radiation performance.

In some embodiments, the wearable device 100 further includes a battery E, and the battery E may be disposed between the first circuit board 30 and the display 10. In another embodiment, the battery E may alternatively be disposed between the bottom housing 20 and the first circuit board 30.

In some embodiments, the first antenna structure A1 is a cavity antenna structure or a patch antenna structure.

Because both the cavity antenna structure and the patch antenna structure can concentrate first electromagnetic wave signals, radiation directivity can be optimized and radiation efficiency can be enhanced.

The display 10 may be, but is not limited to, a display such as a liquid crystal display (LCD), an organic light-emitting diode display (OLED), a pinhole display (Dot Matrix Display), a flexible display (Flexible Display), or a curved display (Curved Display). When the display 10 is the LCD display or the OLED display, the display 10 may alternatively be a touchscreen or a non-touchscreen. When the display 10 is a touchscreen, the display 10 may be a display such as a capacitive touchscreen, a resistive touchscreen, an acoustic touchscreen, a force-based touchscreen, or a light-based touchscreen.

A material of the first conductor 21 may be, but is not limited to, a conductive metal, a conductive alloy, a conductive polymer material, or the like.

In some embodiments, a resonance frequency of the first antenna structure A1 is determined based on at least a length of a long side and/or a length of a short side of the first conductor 21. As a result, the resonance frequency of the first antenna structure A1 may be adjusted to a target resonance frequency by adjusting the length of the long side and/or the length of the short side of the first conductor 21.

A shape of a projection of the first conductor 21 projected on the first circuit board 30 may be, but is not limited to, a circle, an ellipse, a rectangle, a square, a rhombus, an irregular shape, or the like. When the shape of the projection of the first conductor 21 projected on the first circuit board 30 is a circle, a projection of the long side and the short side of the first conductor 21 projected on the first circuit board 30 may be understood as a diameter of the circle. When the shape of the projection of the first conductor 21 projected on the first circuit board 30 is an ellipse, a projection of the long side and the short side of the first conductor 21 projected on the first circuit board 30 may be understood as a major radius and a minor radius of the ellipse. When the shape of the projection of the first conductor 21 projected on the first circuit board 30 is a rectangle, a projection of the long side and the short side of the first conductor 21 projected on the first circuit board 30 may be understood as a long side and a short side of the rectangle. When the shape of the projection of the first conductor 21 projected on the first circuit board 30 is a rhombus, a projection of the long side and the short side of the first conductor 21 projected on the first circuit board 30 may be understood as two diagonal lines of the rhombus.

In some embodiments, as shown in FIG. 2, the bottom housing 20 further includes a bottom housing body 22; and the first conductor 21 is a metal sheet disposed in the bottom housing body 22; or the first conductor 21 is a metal layer formed on an inner surface and/or an outer surface of the bottom housing body 22 in a preparation process. Because the first antenna structure A1 includes the first conductor 21, there is a corresponding special requirement for a shape and a structure of the first conductor 21, to improve radiation performance. The bottom housing 20 includes the bottom housing body 22, and a structure of the bottom housing body 22 allows for a more diversified design. Therefore, this can better adapt to an appearance design requirement of the wearable device 100.

The inner surface of the bottom housing body 22 means a surface that is of the bottom housing body 22 and that faces an interior of the wearable device 100, for example, a surface that faces a side of the first circuit board 30. Correspondingly, the outer surface of the bottom housing body 22 means a surface that is of the bottom housing body 22 and that is away from the interior of the wearable device 100, namely, a surface that is away from the side of the first circuit board 30.

A material of the bottom housing body 22 is an insulating material, and specifically, may be, but is not limited to, any one or a combination of plastic, fiber composite material, glass, ceramic, or the like.

“And/or” describes only a same field for describing associated objects and represents that three relationships may exist. For example, A and/or B may represent the following three cases: Only A exists, both A and B exist, and only B exists. In addition, the character “/” in this specification generally indicates an “or” relationship between the associated objects.

When the first conductor 21 is a metal sheet disposed in the bottom housing body 22, specifically, the first conductor 21 may be embedded in the bottom housing body 22. For example, in a preparation process, a mounting gap is reserved in the bottom housing body 22. The first conductor 21 may be mounted in the mounting gap, and when a size of the first conductor 21 matches the mounting gap, the first conductor 21 can be well prevented from moving relative to the bottom housing body 22. Alternatively, in a preparation process, a material of the bottom housing body 22 is in a fluid state, the bottom housing body 22 wraps the metal sheet, and then after curing, the bottom housing 20 that embeds and wraps the metal sheet is formed. Alternatively, the first conductor 21 is a metal sheet disposed on the inner surface and/or the outer surface of the bottom housing body 22, that is, the first conductor 21 and the bottom housing body 22 may be of a split structure. Further, the first conductor 21 is connected to the inner surface and/or the outer surface of the bottom housing body 22, and a connection manner may be bonding, or another connection manner. However, because the first conductor 21 is used as an antenna radiator, compared with the another connection manner such as a screw connection, the bonding connection manner has less impact on current distribution of the first conductor 21. The first conductor 21 and the inner surface and the outer surface of the bottom housing body 22 may not be connected by using a connector, but abut against each other under actions of devices inside the wearable device 100. Regardless of the manner, mutual displacement between the first conductor 21 and the bottom shell body 22 is unlikely to occur.

The first conductor 21 is a metal layer formed on the inner surface and/or the outer surface of the bottom housing body 22 by using PDS (Printing-Direct-Structuring) or LDS (Laser-Direct-Structuring), that is, the first conductor 21 and the bottom housing body 22 are of an integrated structure. This can completely avoid displacement between the first conductor 21 and the bottom housing body 22, and facilitate mounting. That the first conductor 21 is formed on the inner surface and/or the outer surface of the bottom housing body 22 by using the LDS may be that the bottom housing body 22 (a product injection molded by using a special plastic particle) is activated by a laser machine, and is then the inner surface and/or the outer surface of the bottom housing body 22 is plated with the first conductor 21. That the first conductor 21 is formed on the inner surface and/or the outer surface of the bottom housing body 22 by using the PDS may be that the first conductor 21 is printed on the inner surface and/or the outer surface of the bottom housing body 22, and then the first conductor 21 is formed on the inner surface and/or the outer surface of the bottom housing body 22 through thermal curing. In another embodiment, the first conductor 21 may be formed on the inner surface and/or the outer surface of the bottom housing body 22 in another process. This is not limited herein.

In another embodiment, the bottom housing 20 may alternatively be fully made of a conductive material, that is, the bottom housing 20 is the first conductor 21. In this case, the bottom housing 20 may include only the first conductor 21, but does not include the bottom housing body 22.

In some embodiments, a metal pillar (not marked) may be disposed at a position corresponding to the first feed point F1 on a side that is of the first conductor 21 and that is close to the first circuit board 30, and a metal dome (not marked) is disposed on a side that is of the first circuit board 30 and that faces the first conductor 21. The metal dome is electrically connected to the first feed V1, and the metal pillar is electrically connected to the metal dome, so that the first feed V1 is electrically connected to the first feed point F1 on the first conductor 21. In another embodiment, the first feed V1 and the first feed point F1 may be electrically connected in another manner, which is not limited to this example.

In some other embodiments, when the first conductor 21 is formed on the inner surface of the bottom housing body 22, the metal pillar may be not disposed on the first conductor 21, but the metal dome is disposed only on the side that is of the first circuit board 30 and that faces the first conductor 21, and the first feed V1 is electrically connected to the first feed point F1 through the metal dome.

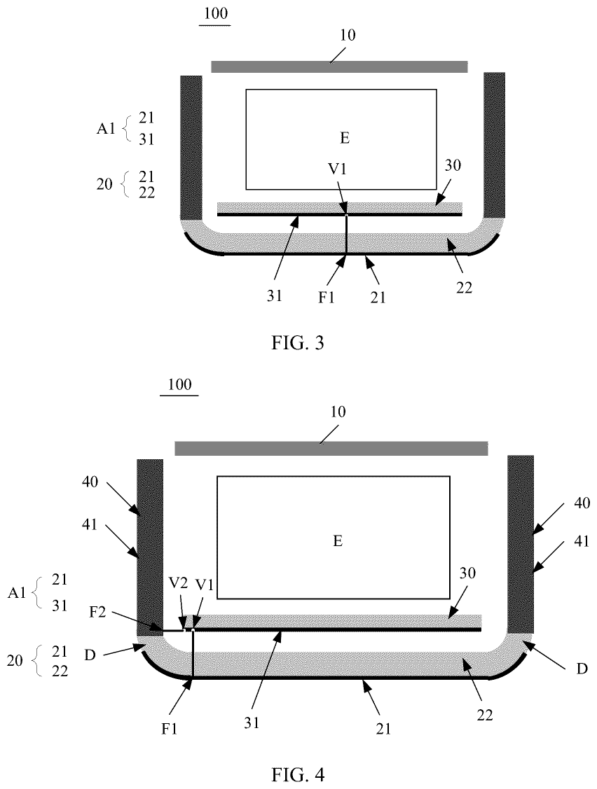

Refer to FIG. 2 and FIG. 3. In some embodiments, as shown in FIG. 2, the first feed point F1 is provided in an edge region or a middle region of the first conductor 21; or as shown in FIG. 3, the first feed point F1 is provided in a middle region of the first conductor 21. Because a mode in which the first feed point F1 is provided in the edge region of the first conductor 21 is different from a mode in which the first feed point is provided in the middle region of the first conductor 21, corresponding electromagnetic wave signals may be generated by the first antenna structure A1 in different modes.

The middle region is a region including a center of the first conductor 21, for example, a region corresponding to reducing an overall shape of the wearable device 100 by 1/2 by using the center of the first conductor 21 as a center. The edge region is a non-middle region of the first conductor 21, or may be a part of the non-middle region. For example, the edge region may alternatively be only a region close to a periphery of the first conductor 21. It should be learned that the middle region and the edge region may alternatively be divided in another manner, which is not limited to this example.

In some embodiments, as shown in FIG. 4, the wearable device 100 further includes: a second feed V2 and a side frame 40, and the side frame 40 includes a second conductor 41; the second conductor 41 includes a second feed point F2, the side frame 40 is disposed between the display 10 and the bottom housing 20, and there is a gap D between the second conductor 41 and the first conductor 21; and the second feed V2 is electrically connected to the second feed point F2, and the second feed V2 is configured to excite the second conductor 41 through the second feed point F2, to generate a second electromagnetic wave signal.

As a result, a structure of the side frame 40 of the wearable device 100 can be fully utilized. The side frame 40 has a support function, and the second feed V2 can further excite the second conductor 41 on the side frame 40 to generate the second electromagnetic wave signal, thereby implementing a plurality of functions. In addition, an antenna structure that is excited to generate the first electromagnetic wave signal and an antenna structure that is excited to generate the second electromagnetic wave signal are different, and a position at which excitation is performed to generate the first electromagnetic wave signal and a position at which excitation is performed to generate the second electromagnetic wave signal are different. Therefore, a performance requirement of the wearable device can also be met while dimension requirements of the bottom housing 20 and the side frame 40 of the wearable device 100 are met.

In some embodiments, the side frame 40 is disposed between the display 10 and the bottom housing 20, and fits with the display 10 and the bottom housing 20 to form a housing of the wearable device 100.

The side frame 40 may be fully made of a conductive material, the side frame 40 is an integral side frame, and the entire side frame 40 is the second conductor 41. In some embodiments, the side frame 40 is made of a conductive material, the side frame 40 is further divided into a plurality of side frame segments by gaps, and the second conductor 41 may be one or some of the side frame sections.

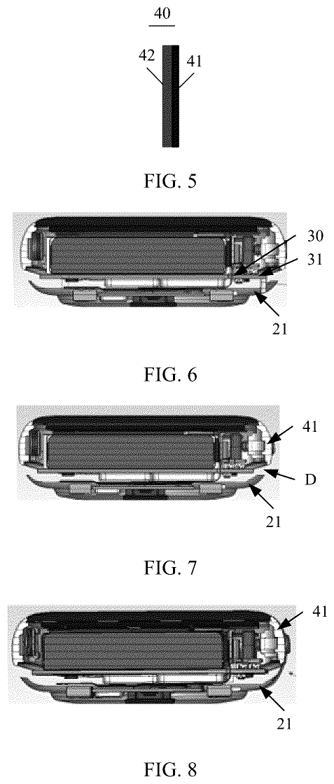

As shown in FIG. 5, the side frame 40 may further include the second conductor 41 and a side frame body 42. The second conductor 41 may be a metal sheet disposed on the side frame body 42, or the second conductor 41 is a metal layer formed on an inner surface and/or an outer surface of the side frame body 42 in a preparation process. For a manner in which the second conductor 41 is disposed on the side frame body 42, refer to a manner in which the first conductor 21 is disposed in the bottom housing body 22. Details are not described herein again.

When the bottom housing 20 further includes the bottom housing body 22, regardless of whether the side frame 40 is made of a conductive material or made of an insulating material, the first conductor 21 may be disposed at a middle position of the bottom housing body 22. A peripheral region of the bottom housing body 22 is closely connected to the side frame 40. This ensures sealing of the housing of the wearable device 100, and ensures that the first conductor 21 and the second conductor 41 are insulated from each other, that is, there is the gap D. When the bottom housing 20 is fully made of a conductive material, regardless of whether the side frame 40 is made of a conductive material or made of an insulating material, the bottom housing 20 and an end part that is of the side frame 40 and that is close to the bottom housing 20 may be connected through an insulator in a sealed manner. This ensures sealing of the housing of the wearable device 100, and ensures that the first conductor 21 and the second conductor 41 are insulated from each other, that is, there is the gap D.

In some embodiments, the gap D between the second conductor 41 and the first conductor 21 is used for at least the first electromagnetic wave signal to radiate outward from the wearable device 100. As the screen-to-body ratio increases, a size of the gap D between the second conductor 41 and the first conductor 21 does not need to be reduced. Therefore, the size of the gap D between the second conductor 41 and the first conductor 21 may be appropriately set, to avoid the attenuation of the first electromagnetic wave signal due to a reduced size of the gap D, thereby avoiding a reduction in the coverage of the first electromagnetic wave signal.

In some embodiments, as shown in FIG. 6, the first conductor 21 is partially electrically connected to the first conductor layer 31 of the first circuit board 30. FIG. 7 is a diagram before the connection and is provided here for comparison and ease of viewing. When the wearable device 100 is worn, the bottom housing 20 is close to skin of a human body. The bottom housing 20 includes the first conductor 21. There is the gap D between the second conductor 41 and the first conductor 21, and the gap D between the second conductor 41 and the first conductor 21 is used for at least the first electromagnetic wave signal to radiate outward from the wearable device 100. However, in some scenarios, for example, when the wearable device 100 is worn tightly on the human body, the wearable device 100 is pressed against the human body, causing a part of the wearable device 100 to be indented into the skin. As a result, a part that is of the gap D between the second conductor 41 and the first conductor 21 and that corresponds to the part indented into the skin is blocked (for example, for a smartwatch, regions near 12 o'clock and 6 o'clock positions of a gap D in the smartwatch are usually not blocked due to a watch strap, while regions near 9 o'clock and 3 o'clock positions of the gap D in the smartwatch are usually blocked due to being close to the human body). Because the human body is a dielectric, the human body affects, by covering or blocking the gap D, the electric field generated by the first antenna structure A1. The first conductor 21 is partially electrically connected (directly short-circuited or connected through a low-impedance lumped or distributed component) to the first conductor layer 31 of the first circuit board 30, to eliminate or reduce impact on the electric field generated by the first antenna structure caused by the human body blocking the gap. Therefore, when a part of the wearable device is indented into the skin, good radiation performance can still be ensured.

Further, when the human body covers or blocks the gap D, the human body absorbs energy, and converts a part of electromagnetic wave energy into thermal energy, thereby causing a loss of the electromagnetic wave energy. The human body is a dielectric, and when covering or blocking the gap D, the human body is equivalent to impedance, affecting a resonance frequency of the first antenna structure A1. Therefore, the first conductor 21 is partially electrically connected to the first conductor layer 31 of the first circuit board 30, so that losses of the resonance frequency and electromagnetic wave signal energy of the first antenna structure A1 caused by human body impedance may be eliminated or reduced.

The first conductor 21 and the first conductor layer 31 of the first circuit board 30 may be directly short-circuited or connected through a lumped or distributed device with small impedance. In this case, the first conductor 21 and the first conductor layer 31 of the first circuit board 30 are equivalent to being partially short-circuited, thereby eliminating or reducing impact on an electric field in the scenario in which the part of the wearable device 100 is indented into the skin.

That the first conductor 21 is partially electrically connected to the first conductor layer 31 of the first circuit board 30 means a partial region of the first conductor 21 is electrically connected to a partial region of the first conductor layer 31. In some embodiments, the partial region of the first conductor 21 and the partial region of the first conductor layer 31 may mean regions that may be blocked when the wearable device 100 is worn on the human body. For example, when the wearable device 100 is a smartwatch, the partial region of the first conductor 21 and the partial region of the first conductor layer 31 may include regions that are of the first conductor 21 and the first conductor layer 31 and that are located at 3 o'clock and 9 o'clock positions.

In some embodiments, as shown in FIG. 8, the first conductor 21 is partially electrically connected to the second conductor 41. The first conductor 21 and the second conductor 41 may be directly short-circuited or connected through a lumped or distributed device with small impedance.

Similarly, the first conductor 21 is partially electrically connected to the second conductor 41, so that impact on the electric field of the first antenna structure A1 caused by the human body blocking the gap D may also be eliminated or reduced. For details, refer to the foregoing descriptions of the partial electrical connection between the first conductor 21 and the first conductor layer 31 of the first circuit board 30 for understanding.

That the first conductor 21 is partially electrically connected to the second conductor 41 means a partial region of the first conductor 21 is electrically connected to a partial region of the second conductor 41. In some embodiments, the partial region of the first conductor 21 and the partial region of the second conductor 41 may mean partial regions that are of the wearable device 100 and that may be indented into the skin when the wearable device 100 is worn on the human body. For example, when the wearable device 100 is a smartwatch, the partial region of the first conductor 21 and the partial region of the second conductor 41 may include regions that are of the first conductor 21 and the second conductor 41 and that are located at 3 o'clock and 9 o'clock positions.

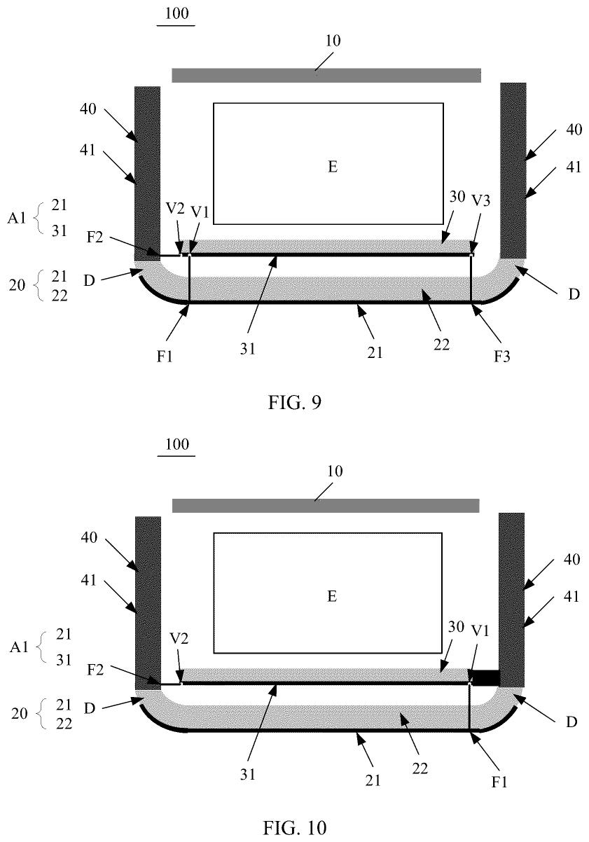

In some embodiments, as shown in FIG. 9, the wearable device 100 further includes a third feed V3, and the third feed V3 is disposed on the first circuit board 30. The first conductor 21 further includes a third feed point F3, the third feed point F3 is spaced apart from the first feed point F1, and the third feed V3 is connected to the third feed point F3, and is configured to excite the first antenna structure A1 through the third feed point F3, to generate a third electromagnetic wave signal. As a result, the first antenna structure A3 may be excited by using a plurality of feeds to generate corresponding electromagnetic wave signals.

The wearable device 100 may further include several feeds (3 or more), the several feeds are all disposed on the first circuit board 30, and the first conductor 21 includes several feed points corresponding to the several feeds. The several feeds may excite the first antenna structure A1 through the corresponding several feed points to generate several electromagnetic wave signals, where the several feed points are spaced apart from each other.

In some embodiments, as shown in FIG. 4, the second feed V2 is disposed on the first circuit board 30. Because various electronic components are conveniently disposed on the first circuit board 30, it is simple to dispose the second feed V2 on the first circuit board 30.

In some embodiments, as shown in FIG. 10, an edge part that is of the first conductor layer 31 of the first circuit board 30 and that is close to the first feed point F1 is electrically connected to the second conductor 41. The second feed V2 is disposed on the first circuit board 30, and the second feed V2 excites the second conductor 41 through the second feed point F2, to generate a corresponding electric field on the first circuit board 30. The electric field affects the first electromagnetic wave signal generated by the first feed V1 exciting the first antenna structure A1 through the first feed point F1. Therefore, the edge part that is of the first conductor layer 31 of the first circuit board 30 and that is close to the first feed point F1 is electrically connected to the second conductor 41, reducing this impact.

The edge part that is of the first conductor layer 31 and that is close to the first feed point F1 and the second conductor 41 may be directly short-circuited or connected through a lumped or distributed device with small impedance. In another embodiment, the edge part of the first feed point F1 may be electrically connected to the second conductor 41 in another manner. This is not limited herein.

Further, connection lines between a center of the first circuit board 30 and positions of projections of the first feed point F1 and the second feed point F2 on a plane on which the first circuit board 30 is located do not coincide with each other, that is, there is an angle between the two connection lines and the angle is greater than 0° and less than 360°, for example, ranges from 90° to 270°. As a result, when electrically connected to the second conductor 41, the edge part that is of the first conductor layer 31 and that is close to the first feed point F1 is staggered from a feed path of the second feed V2. This reduces short-circuit impact on the second feed V2 in exciting the second conductor 41 through the second feed point F2 to generate the second electromagnetic wave signal.

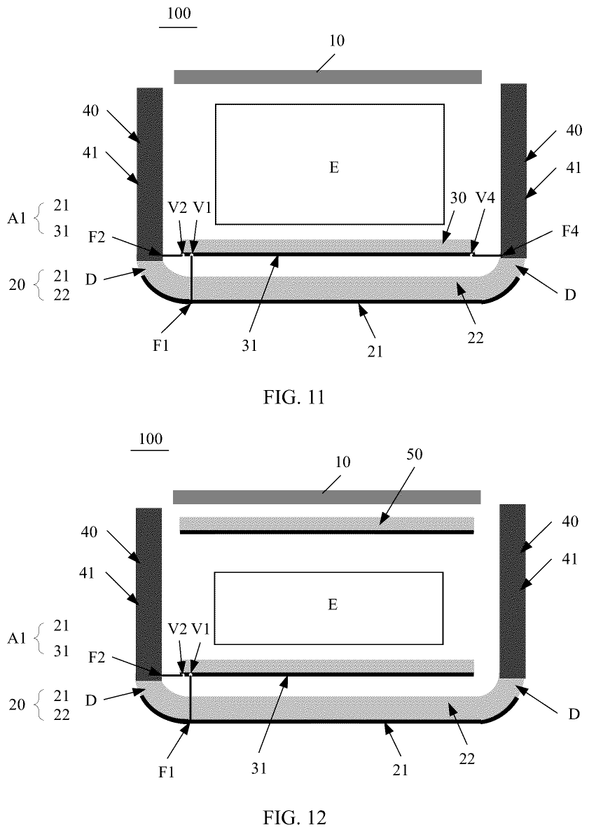

In some embodiments, as shown in FIG. 11, the wearable device 100 further includes a fourth feed V4, the second conductor 41 further includes a fourth feed point F4, the fourth feed point F4 is spaced apart from the second feed point F2, the fourth feed V4 is disposed on the first circuit board 30 and is connected to the fourth feed point F4, and the fourth feed V4 excites the second conductor 41 through the fourth feed point F4, to generate a fourth electromagnetic wave signal. As a result, the first feed V1, the second feed V2, and the fourth feed V4 may be disposed on the first circuit board 30, and the first feed V1 excites the first antenna structure A1 through the first feed point F1 to generate the first electromagnetic wave signal. Both the second feed V2 and the fourth feed V4 generate corresponding electromagnetic wave signals by exciting the second conductor 41.

The wearable device 100 may further include several feeds (3 or more), the several feeds are all disposed on the first circuit board 30, and the second conductor 41 includes several feed points corresponding to the several feeds. The several feeds may excite the second conductor 41 through the corresponding several feed points to generate several electromagnetic wave signals, where the several feed points are spaced apart from each other.

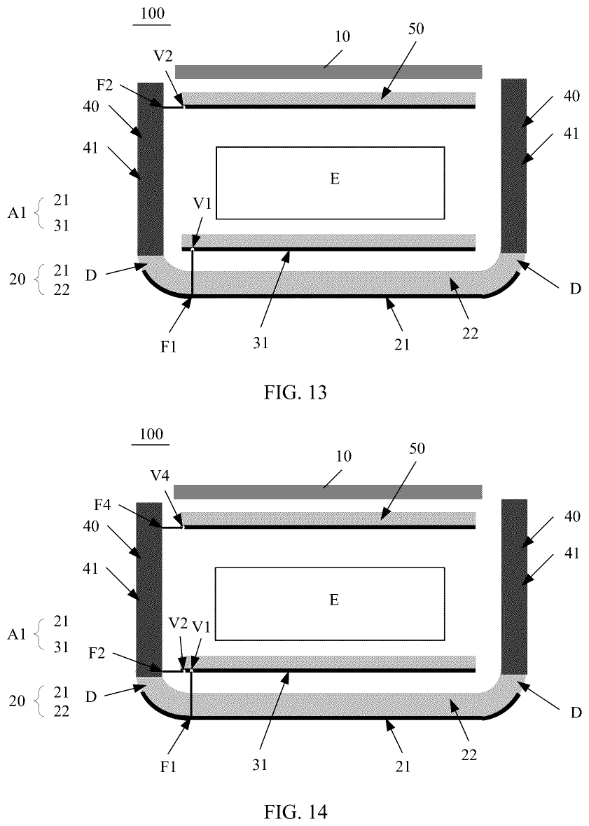

In some embodiments, as shown in FIG. 12 and FIG. 13, the wearable device 100 further includes a second circuit board 50; the second circuit board 50 is disposed between the first circuit board 30 and the display 10; and the second feed V2 is disposed on the first circuit board 30 (as shown in FIG. 12) or the second circuit board 50 (as shown in FIG. 13). As a result, when the wearable device 100 includes the first circuit board 30 and the second circuit board 50, and the first feed V1 is disposed on the first circuit board 30, the second feed V2 may be disposed on the first circuit board 30 or the second circuit board 50. Therefore, when the disposition is based on performance required by the wearable device 100 and an arrangement requirement between components, the second feed V2 disposed on the first circuit board 30 or the second circuit board 50 may be configured to excite the second conductor 41 to generate a corresponding electromagnetic wave signal.

In some embodiments, as shown in FIG. 14, the second feed V2 is disposed on the first circuit board 30, the wearable device 100 further includes a fourth feed V4, the second conductor 41 further includes a fourth feed point F4, the fourth feed V4 is disposed on the second circuit board 50 and is connected to the fourth feed point F4, and the fourth feed V4 excites the second conductor 41 through the fourth feed point F4, to generate a fourth electromagnetic wave signal. As a result, when the disposition is based on a dimension of the wearable device 100, a required frequency band, and an arrangement requirement between components, the wearable device 100 can support receiving and sending of a plurality of electromagnetic wave signals in the following manner: The first feed V1 disposed on the first circuit board 30 may excite the first antenna structure A1 to generate the first electromagnetic wave signal, and the second feed V2 disposed on the first circuit board 30 may excite the second conductor 41 to generate the second electromagnetic signal. The fourth feed V4 disposed on the second circuit board 50 may excite the second conductor 41 to generate the fourth electromagnetic wave signal.

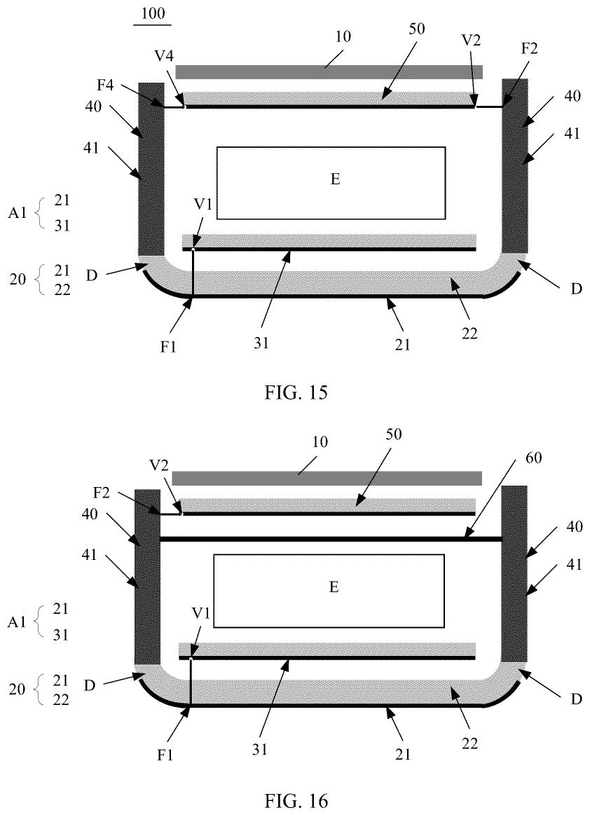

In some embodiments, as shown in FIG. 15, similarly, the wearable device 100 further includes a fourth feed V4, the second conductor further includes a fourth feed point F4, the fourth feed V4 is connected to the fourth feed point F4, and is configured to excite the second conductor 41 through the fourth feed point F4, to generate a fourth electromagnetic wave signal. A difference between a structure shown in FIG. 15 and a structure shown in FIG. 14 lies in that both the second feed V2 and the fourth feed V4 are disposed on the second circuit board 50. As a result, when the disposition is based on a dimension of the wearable device 100, a required frequency band, and an arrangement requirement between components, the wearable device 100 may further support receiving and sending of a plurality of electromagnetic wave signals in the following manner: The first feed V1 disposed on the first circuit board 30 may excite the first antenna structure A1 to generate the first electromagnetic wave signal, and the second feed V2 disposed on the second circuit board 50 may excite the second conductor 41 to generate the second electromagnetic signal. The fourth feed V4 disposed on the second circuit board 50 may excite the second conductor 41 to generate the fourth electromagnetic wave signal.

The wearable device 100 may further include several other feeds (3 or more), the several other feeds are all disposed on second circuit board 50, and the second conductor 41 includes several other feed points correspondingly electrically connected to the several other feeds. The several other feeds may excite the second conductor 41 through the corresponding several feed points to generate several other electromagnetic wave signals, where the several other feed points are spaced apart from each other. The other feeds and the fourth feed V4 may be the same or different, and the other electromagnetic wave signals may be fourth electromagnetic wave signals or electromagnetic wave signals different from the fourth electromagnetic wave signal.

In some embodiments, as shown in FIG. 16, the wearable device 100 further includes a third conductor 60; the third conductor 60 is disposed between the first circuit board 30 and the second circuit board 50, and is spaced apart from both the first circuit board 30 and the second circuit board 50; a periphery of the third conductor 60 is connected to an inner surface of the second conductor 41, or a periphery of the third conductor 60 is spaced apart from an inner surface of the second conductor 41 and the spacing is less than or equal to a preset distance; and the third conductor 60 is configured to at least isolate an electromagnetic wave signal generated through excitation by a feed disposed on the first circuit board 30 and an electromagnetic wave signal generated through excitation by a feed disposed on the second circuit board 50 from each other. In this way, this can improve isolation between the electromagnetic wave signal generated by excitation of the feed on the first circuit board 30 and the electromagnetic wave signal generated by excitation of the feed on the second circuit board 50.

The periphery of the third conductor 60 is connected to the inner surface of the second conductor 41, and a connection manner may be, but is not limited to, welding, bonding by using conductive glue, or the like.

The preset distance may be a small value, for example, a value less than 10 mm. When the periphery of the third conductor 60 is spaced apart from the inner surface of the second conductor 41, and the spacing is less than or equal to the preset distance, an electromagnetic wave signal generated through excitation by a feed disposed on the first circuit board 30 and an electromagnetic wave signal generated through excitation by a feed disposed on the second circuit board 50 may also be well isolated from each other.

In some embodiments, the battery E is disposed between the first circuit board 30 and the display 10. Specifically, the battery E may be disposed between the first circuit board 30 and the third conductor 60. In another embodiment, the battery E is disposed between the first circuit board 30 and the display 10, or disposed between the third conductor 60 and the second circuit board 50, or disposed between the second circuit board 50 and the display 10, or the like. Alternatively, the battery E may be disposed in another manner. This is not limited herein.

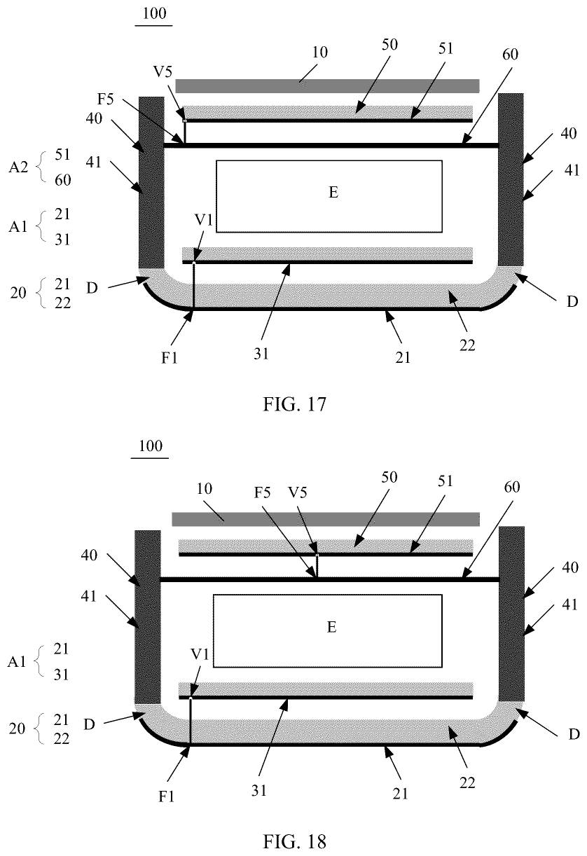

In some embodiments, as shown in FIG. 17, at least a part of the third conductor 60 is parallel to the second circuit board 50, the second circuit board 50 includes a second conductor layer 51, the third conductor 60 includes a fifth feed point F5, the wearable device 100 further includes a fifth feed V5, the fifth feed V5 is disposed on the second circuit board 50, and the fifth feed V5 excites the second antenna structure A2 through the fifth feed point F5, to generate a fifth electromagnetic wave signal, where the second antenna structure A2 includes at least the third conductor 60 and the second conductor layer 51 of the second circuit board 50. As a result, when the disposition is based on a dimension of the wearable device 100, a required frequency band, and an arrangement requirement between components, the following solution may also be provided for selection: The fifth feed V5 disposed on the second circuit board 50 excites the second antenna structure A2 to generate the fifth electromagnetic wave signal, where the second antenna structure A2 includes at least the third conductor 60 and the second conductor layer 51 of the second circuit board 50.

The third conductor 60 and the second circuit board 50 are also approximately parallel to the bottom housing 20 (that is, may not be completely parallel, allowing for a specific tilt, for example, a tilt within 10 degrees).

In some embodiments, that at least the part of the third conductor 60 is parallel to the second circuit board 50 means that at least a part of a surface that is of the third conductor 60 and that has a largest area is parallel to a surface that is of the second circuit board 50 and that has a largest area.

In some embodiments, the second conductor layer 51 included in the second circuit board 50 is a structure at a specific layer of the second circuit board 50, and is parallel to the surface that is of the second circuit board 50 and that has the largest area. Therefore, the at least part of the third conductor 60 is parallel to the second circuit board 50, that is, the at least the part of the third conductor 60 is parallel to the second conductor layer 51 included in the second circuit board 50.

Similarly, when the wearable device 100 further includes the third conductor 60, and the second antenna structure A2 includes at least the third conductor 60 and the second conductor layer 51 of the second circuit board 50, the wearable device 100 may further include several other feeds (2 or more), the several other feeds are all disposed on second circuit board 50, and the third conductor 60 includes several feed points corresponding to the several other feeds. The several other feeds may excite the second antenna structure A2 through the corresponding several other feed points to generate several electromagnetic wave signals, where the several other feed points are spaced apart from each other. The other feeds and the fifth feed V5 may be the same or different, and the other electromagnetic wave signals may be fifth electromagnetic wave signals or electromagnetic wave signals different from the fifth electromagnetic wave signal.

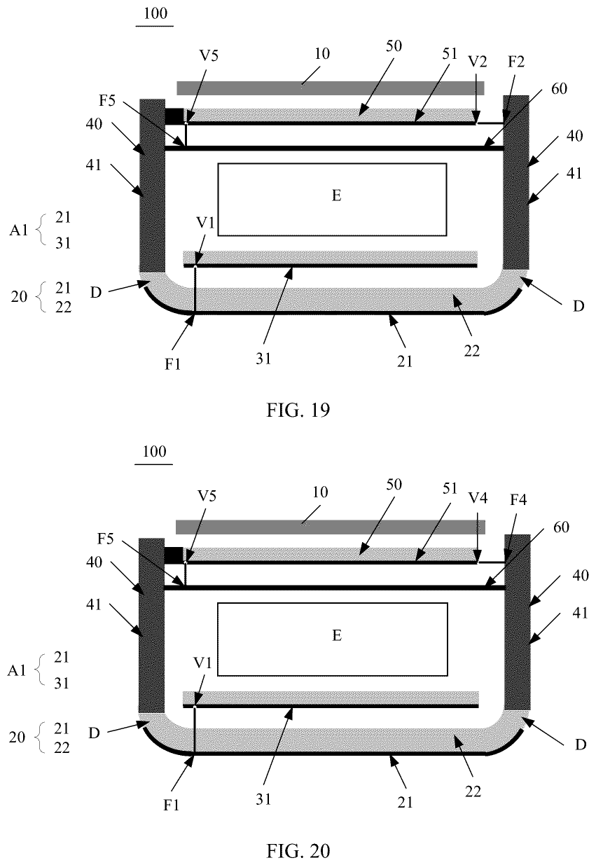

As shown in FIG. 17, the fifth feed point F5 may alternatively be located in an edge region of the third conductor 60; or as shown in FIG. 18, the fifth feed point F5 may alternatively be located in a middle region of the third conductor 60. For explanations of the middle region and the edge region, refer to the foregoing descriptions explaining that the first feed point F1 may be located in the middle region or the edge region of the first conductor 21. Details are not described herein again.

As shown in FIG. 19 and FIG. 20, an edge part that is of the second conductor layer 51 of the second circuit board 50 and that is close to the fifth feed point F5 is electrically connected to the second conductor 41. The second feed V2 or the fourth feed V4 is disposed on the second circuit board 50, and the second feed V2 or the fourth feed V4 excites the second conductor 41 through the second feed point F2, to generate a corresponding electric field on the second circuit board 50. The electric field affects the fifth electromagnetic wave signal generated by the fifth feed V5 exciting the second antenna structure A2 through the fifth feed point F5. Therefore, the edge part that is of the second conductor layer 51 of the second circuit board 50 and that is close to the fifth feed point F5 is electrically connected to the second conductor 41, reducing this impact.

The edge part that is of the second conductor layer 51 of the second circuit board 50 and that is close to the fifth feed point F5 and the second conductor 41 may be directly short-circuited or connected through a lumped or distributed device with small impedance. In another embodiment, the edge part that is of the second conductor layer 51 of the second circuit board 50 and that is close to the fifth feed point F5 may be electrically connected to the second conductor 41 in another manner. This is not limited herein.

Further, connection lines between a center of the second circuit board 50 and positions of projections of the fifth feed point F5, the second feed point F2, and the fourth feed point F4 on a plane on which the second circuit board 50 is located do not coincide with each other, that is, there are angles between the three connection lines and the angles between the connection lines between the center of the second circuit board 50 and the positions of the projections of the fifth feed point F5, the second feed point F2, and the fourth feed point F4 on the plane on which the second circuit board 50 is located each are greater than 0° and less than 360°, for example, range from 90° to 270°. As a result, when the edge part that is of the second conductor layer 51 of the second circuit board 50 and that is close to the fifth feed point F5 is electrically connected to the second conductor 41, the second feed V2 can still excite the second conductor 41 through the second feed point F2 to generate the second electromagnetic wave signal, and the edge part is staggered from a feed path of the fourth feed V4 without affecting the fourth feed V4 in exciting the second conductor 41 through the fourth feed point F4 to generate the fourth electromagnetic wave signal.

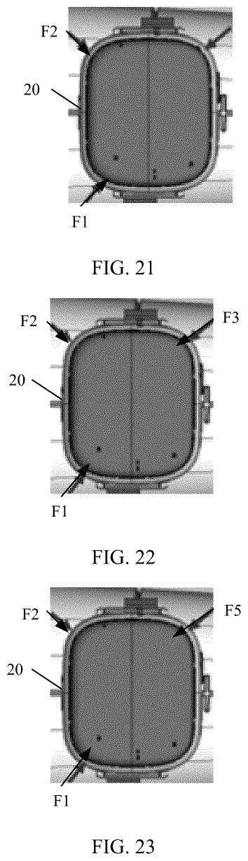

In some embodiments, as shown in FIG. 21, positions of projections of the first feed point F1 and the second feed point F2 on the first circuit board 30 are the same or different; the first electromagnetic wave signal and the second electromagnetic wave signal are signals among Wi-Fi signals, Bluetooth signals, GPS signals, and cellular signals; and the first electromagnetic wave signal and the second electromagnetic wave signal are the same or different. As a result, the wearable device 100 can support a Wi-Fi signal, a Bluetooth signal, a GPS signal, and a cellular signal, which can be implemented by the first feed V1 exciting the first antenna structure A1 through the first feed point F1 and/or the second feed V2 exciting the second conductor 41 through the second feed point F2, regardless of whether the positions of the projections of the first feed point F1 and the second feed point F2 on the first circuit board 30 are the same or different.

In some other embodiments, in addition to the Wi-Fi signals, the Bluetooth signals, the GPS signals, and the cellular signals, the first electromagnetic wave signal and the second electromagnetic wave signal may be signals of another type. This is not limited herein.

In some embodiments, as shown in FIG. 22, positions of projections of the first feed point F1, the second feed point F2, and the third feed point F3 on the first circuit board 30 are different; connection lines between a center of the first circuit board 30 and the positions of the projections of the first feed point F1, the second feed point F2, and the third feed point F3 on the first circuit board 30 are on different radial lines; the first electromagnetic wave signal, the second electromagnetic wave signal, and the third electromagnetic wave signal are signals among Wi-Fi signals, Bluetooth signals, GPS signals, and cellular signals; and the first electromagnetic wave signal, the second electromagnetic wave signal, and the third electromagnetic wave signal are the same, or at least one of the first electromagnetic wave signal, the second electromagnetic wave signal, and the third electromagnetic wave signal is different.

The radial line is a line from the center of the first circuit board 30 to an edge point of the first circuit board 30. When the first circuit board 30 is a circle, that is, a shape of a projection of the first circuit board 30 in a direction perpendicular to a surface that is of the first circuit board 30 and that has a largest area is a circle, the radial line may be understood as a radius line (may not be understood as a diameter line). When the first circuit board 30 is in another shape, that is, a shape of a projection of the first circuit board 30 along a surface that is of the first circuit board 30 and that has a largest area is another shape, because distances between the center of the first circuit board 30 and positions on a periphery of the first circuit board 30 are usually different, the radial line may be understood as radius lines of different lengths.

In some other embodiments, in addition to the Wi-Fi signals, the Bluetooth signals, the GPS signals, and the cellular signals, the first electromagnetic wave signal, the second electromagnetic wave signal, and the third electromagnetic wave signal may be signals of another type. This is not limited herein.

In some embodiments, as shown in FIG. 23, positions of projections of the first feed point F1, the second feed point F2, and the fifth feed point F5 on the first circuit board 30 are different; connection lines between a center of the first circuit board 30 and the positions of projections of the first feed point F1, the second feed point F2, and the fifth feed point F5 on the first circuit board 30 are on different radial lines; the first electromagnetic wave signal, the second electromagnetic wave signal, and the fifth electromagnetic wave signal are signals among Wi-Fi signals, Bluetooth signals, GPS signals, and cellular signals; and the first electromagnetic wave signal, the second electromagnetic wave signal, and the fifth electromagnetic wave signal are the same, or at least one of the first electromagnetic wave signal, the second electromagnetic wave signal, and the fifth electromagnetic wave signal is different.

For the radial line, refer to the foregoing description. In some other embodiments, in addition to the Wi-Fi signals, the Bluetooth signals, the GPS signals, and the cellular signals, the first electromagnetic wave signal, the second electromagnetic wave signal, and the fifth electromagnetic wave signal may be signals of another type. This is not limited herein.

In another embodiment, positions of projections of the first feed point F1 and the fifth feed point F5 on the first circuit board 30 may alternatively be the same.

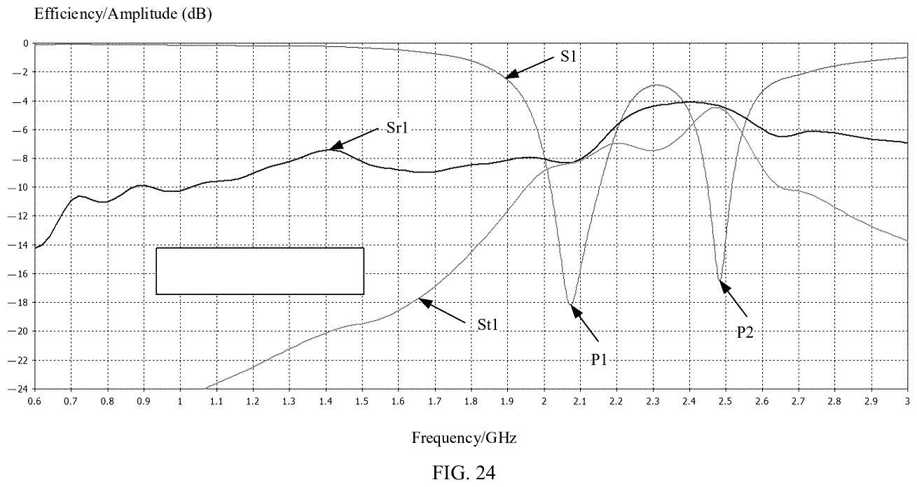

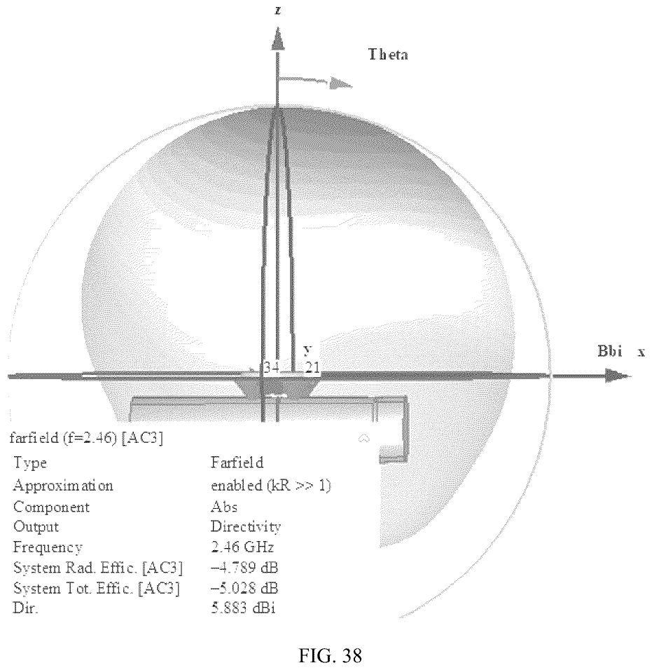

In some embodiments, the wearable device 100 is a smartwatch, with a dimension of appropriately 40 mm×45 mm×12 mm. With the dimension of the entire wearable device, optimal dimensions of the first conductor 21, the first circuit board 30, and the second conductor 41 in the structure shown in FIG. 4 are determined, and simulation test diagrams shown in FIG. 24 and FIG. 38 are obtained through testing by using the optimal dimensions. FIG. 24 shows a return loss curve S1, a system radiation efficiency curve Sr1, and a total system efficiency curve St1 of a first antenna structure A1 receiving and transmitting electromagnetic wave signals under excitation by a first feed V1. In FIG. 24, a horizontal coordinate indicates a frequency (in a unit of GHz), and a vertical coordinate indicates an amplitude (in a unit of dB). An input return loss is a reflection coefficient of the first electromagnetic wave signal generated by the first feed V1 exciting the first antenna structure A1. In general, a frequency corresponding to a minimum point of the input return loss may correspond to a resonance frequency of the first antenna structure A1 under excitation by the first feed V1.

It can be learned from FIG. 24 that the input return loss curve S1 has two minimum points P1 and P2, and frequencies corresponding to the two minimum points P1 and P2 are 2.06 GHz and 2.48 GHz respectively. The 2.06 GHz frequency corresponding to the minimum point P1 is a first resonance frequency of the first antenna structure A1 under excitation by the first feed V1. The 2.48 GHz frequency corresponding to the minimum point P2 is a second resonance frequency of the first antenna structure A1 under excitation by the first feed V1.

It can be learned that, an input return loss of the first antenna structure A1 receiving and transmitting electromagnetic wave signals under excitation by the first feed V1 is low near the first resonance frequency of 2.06 GHz, and the input return loss is also low near the second resonance frequency of 2.48 GHz. As a result, the first antenna structure A1 can operate well near the first resonance frequency and the second resonance frequency.

It can also be learned from FIG. 24 that, the system radiation efficiency curve Sr1 of the first antenna structure A1 receiving and transmitting the electromagnetic wave signals under excitation by the first feed V1 is high in a frequency band from 2.06 GHz to 2.48 GHz, and the total system efficiency curve St1 of the first antenna structure A1 receiving and transmitting the electromagnetic wave signals under excitation by the first feed V1 is also high in the frequency band from 2.06 GHz to 2.48 GHz. As a result, the first antenna structure A1 can operate well in the frequency band from 2.06 GHz to 2.48 GHz under excitation by the first feed V1.

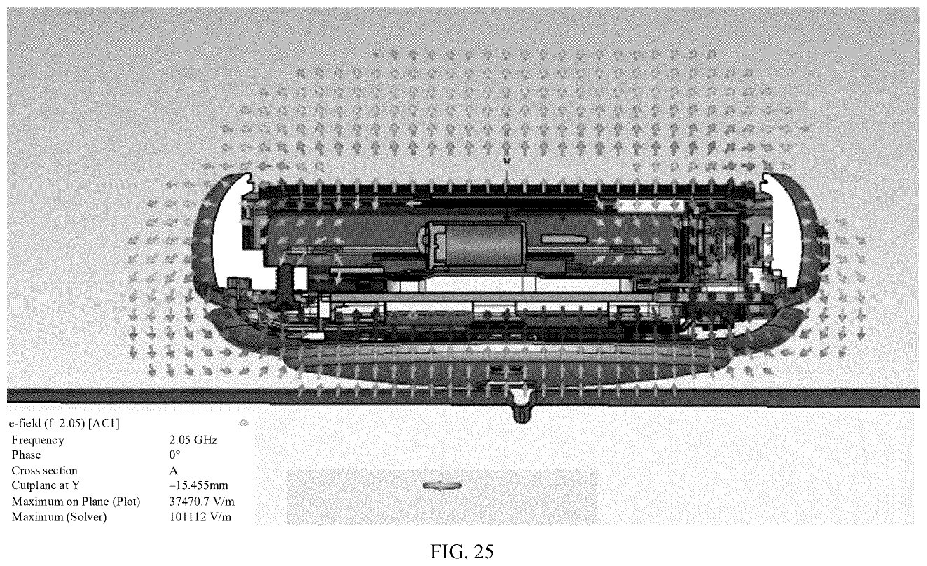

FIG. 25 is a sectional view of electric field distribution of the wearable device 100 present when the first feed V1 excites the first antenna structure A1 to operate at 2.05 GHz that is near the first resonance frequency of 2.06 GHz. FIG. 25 illustrates the wearable device 100 as a smart watch, and may be a sectional view along a 9 o'clock-to-3 o'clock direction of the smart watch. It can be learned from FIG. 25 that, in this case, a normal electric field component of the first antenna structure A1 is large. As a result, an electric field generated by the first antenna structure A1 is unlikely to be absorbed by the human body.

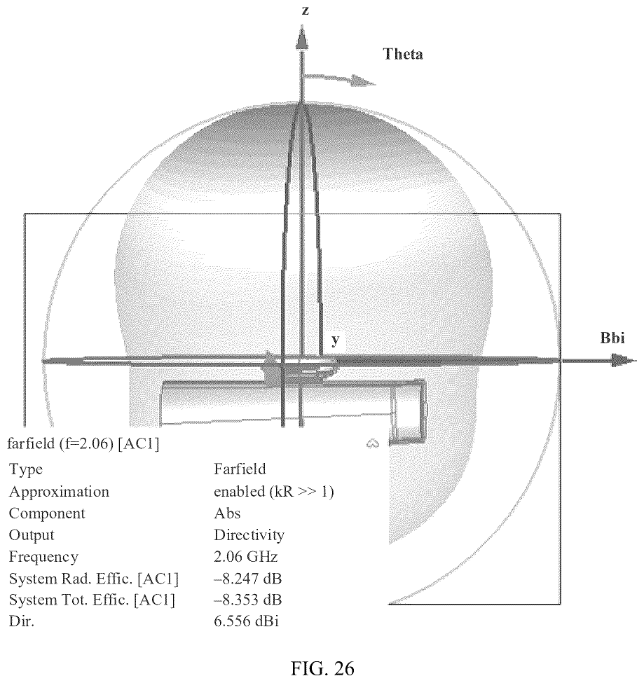

FIG. 26 is an antenna radiation pattern present when the first feed V1 excites the first antenna structure A1 to operate at the first resonance frequency of 2.06 GHz. It can be learned from FIG. 26 that, when operating at the first resonance frequency of 2.06 GHz, the first antenna structure A1 has good radiation in a vertical direction. In this case, antenna directivity is 6.556 dBi. This indicates that the first antenna structure A1 has a stronger capability of radiating or receiving a signal in the vertical direction. The vertical direction may be a direction perpendicular to at least a part of the first conductor 21 and the first circuit board 30.

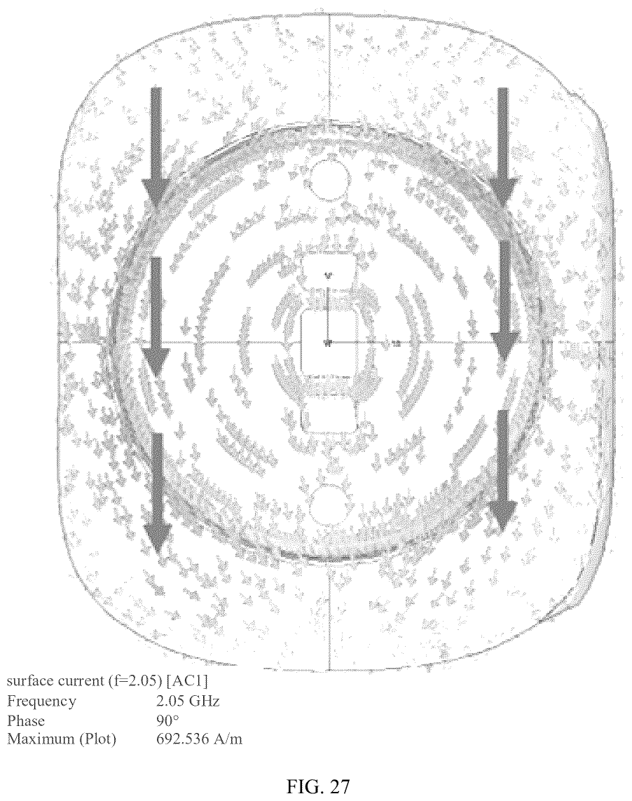

FIG. 27 is a diagram of current distribution present when the first feed V1 excites the first antenna structure A1 to operate at the first resonance frequency of 2.05 GHz. It can be learned from FIG. 27 that, a current flows in a direction of a long side of the first conductor 21. As a result, it may be concluded that a resonance frequency of the first antenna structure A1 is determined based on at least a length of the long side of the first conductor 21.

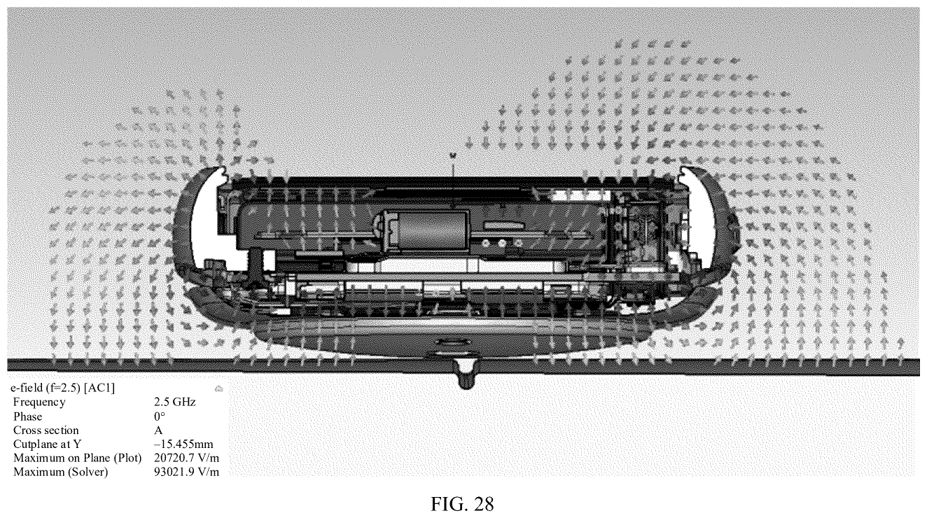

FIG. 28 is a sectional view of electric field distribution present when the first feed V1 excites the first antenna structure A1 to operate at the second resonance frequency of 2.5 GHz. FIG. 28 illustrates the wearable device 100 as a smart watch, and may be a sectional view along a 9 o'clock-to-3 o'clock direction of the smart watch. In this case, a normal electric field component of the first antenna structure A1 is large. As a result, an electric field generated by the first antenna structure A1 is unlikely to be absorbed by the human body.

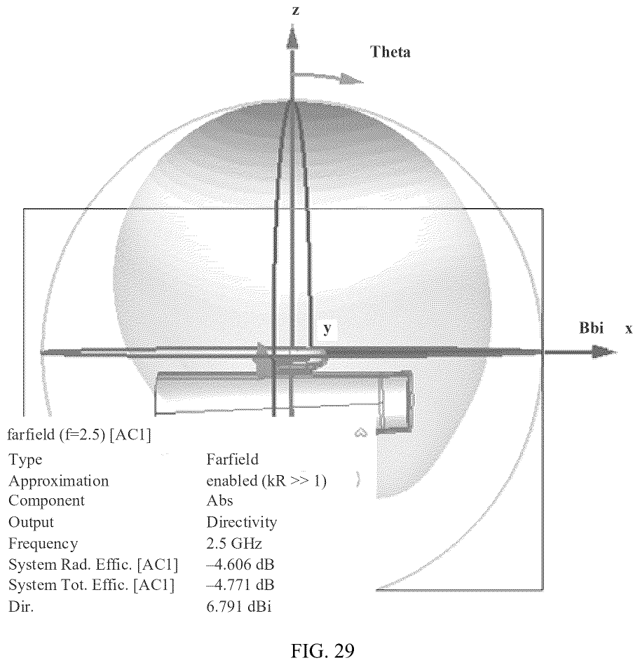

FIG. 29 is an antenna radiation pattern present when the first feed V1 excites the first antenna structure A1 to operate at the second resonance frequency of 2.5 GHz. It can be learned from FIG. 25 that, the first antenna structure A1 has good radiation in the vertical direction. In this case, antenna directivity is 6.791 dBi. This indicates that the first antenna structure A1 has a stronger capability of radiating or receiving a signal in the vertical direction. The vertical direction may be a direction perpendicular to at least a part of the first conductor 21 and the first circuit board 30.

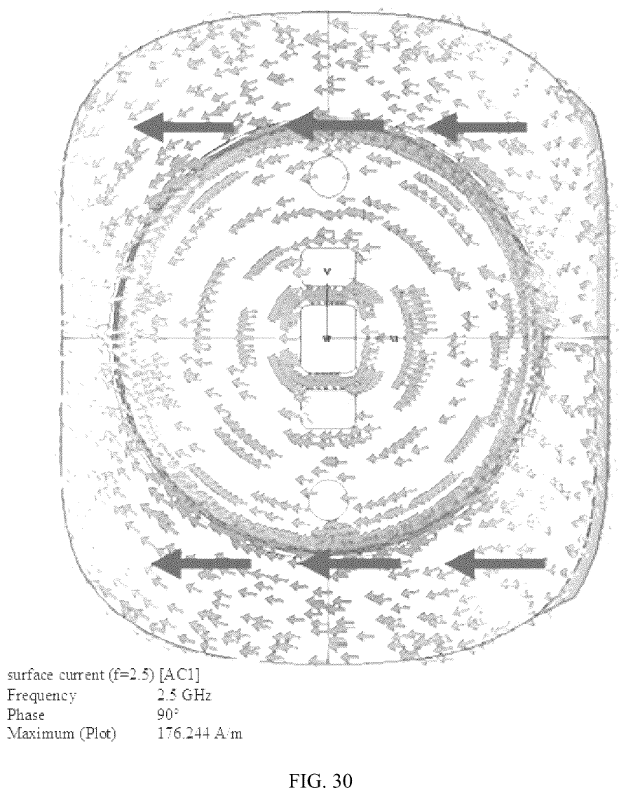

FIG. 30 is a diagram of current distribution present when the first feed V1 excites the first antenna structure A1 to operate at the second resonance frequency of 2.5 GHz. It can be learned from FIG. 30 that, a current flows in a direction of a short side of the first conductor 21. As a result, it may be concluded that a resonance frequency of the first antenna structure A1 is determined based on at least a length of the short side of the first conductor 21.

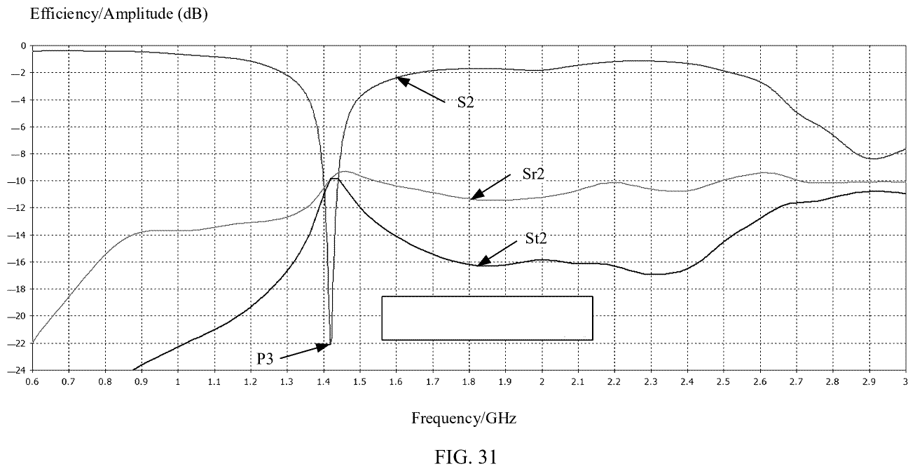

FIG. 31 shows a return loss curve S2, a system radiation efficiency curve Sr2, and a total system efficiency curve St2 of the second feed V2. It can be learned from FIG. 31 that, the input return loss curve S2 has a minimum point P3, and a frequency corresponding to the minimum point P3 is 1.43 GHz, where the 1.43 GHz frequency corresponding to the minimum point P3 is a third resonance frequency of the second conductor 41 under excitation by the second feed V2.

It can be learned that, an input return loss of an electromagnetic wave signal generated by the second feed V2 exciting the second conductor 41 is lower near the third resonance frequency of 1.43 GHz. As a result, the second conductor 41 can well operate near the third resonance frequency.

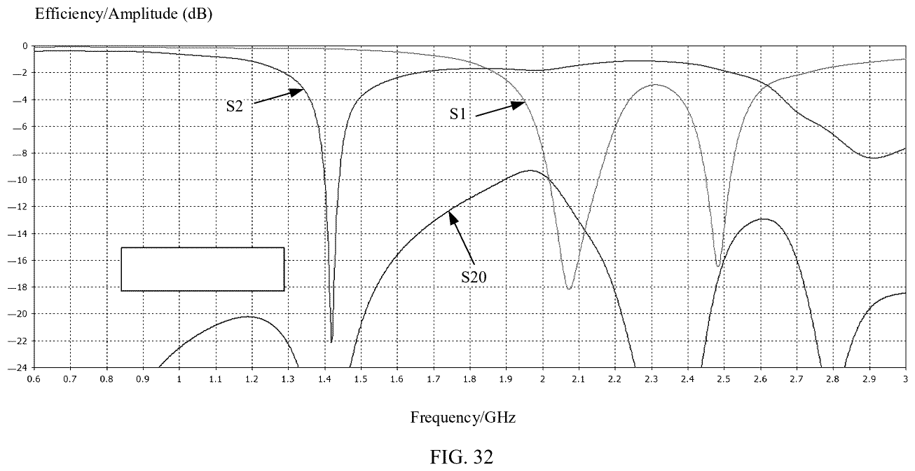

FIG. 32 is a diagram of a first type of return loss curves and an isolation curve of the wearable device 100. FIG. 32 is a diagram of a return loss curve and an isolation curve that are obtained through simulation testing by using an example in which the wearable device 100 including both the first antenna structure A1 and the second conductor 41 in any one of the foregoing embodiments operates in a 2.5 GHz frequency band and a 1.43 GHz frequency band.

Specifically, that the wearable device 100 operates in the 2.5 GHz frequency band may be that the first feed V1 of the wearable device 100 excites the first antenna structure A1 to operate in the 2.5 GHz frequency band. That the wearable device 100 operates in the 1.43 GHz frequency band may be that the second feed V2 of the wearable device 100 excites the second conductor 41 to operate in the 1.43 GHz frequency band.

FIG. 32 shows a return loss curve S1 of the wearable device 100 operating in the 2.5 GHz frequency band and a return loss curve S2 of the wearable device 100 operating in the 1.43 GHz frequency band, and reflects an isolation curve S20 between the 2.5 GHz frequency band and the 1.43 GHz frequency band.

When an absolute value of isolation corresponding to the isolation curve S20 is lower, the isolation is poorer. When an absolute value of isolation corresponding to the isolation curve S20 is higher, the isolation is better. It can be learned from FIG. 32 that, an isolation value corresponding to 2.5 GHz is less than −24 dB, and an isolation value corresponding to 1.43 GHz is appropriately −18 dB. Therefore, it can be learned that isolation between the 2.5 GHz frequency band and the 1.43 GHz frequency band is excellent. During simultaneous operation in the two frequency bands, mutual interference is small.

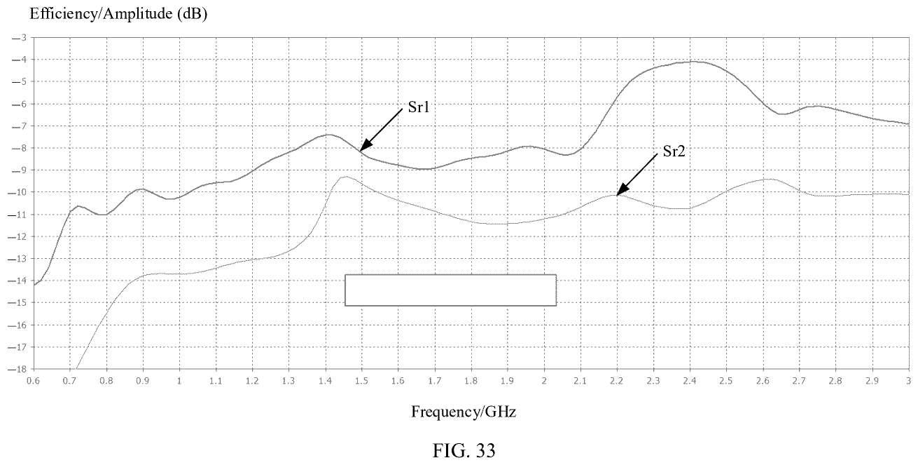

FIG. 33 is a simulation diagram of a system radiation efficiency curve Sr1 of the first feed V1 and a system radiation efficiency curve Sr2 of the second feed V2 in simulation of the wearable device 100 being worn on an arm. It can be learned from FIG. 33 that, system radiation efficiency under excitation by the first feed V1 is higher than system radiation efficiency under excitation by the second feed V2 across an entire frequency band.

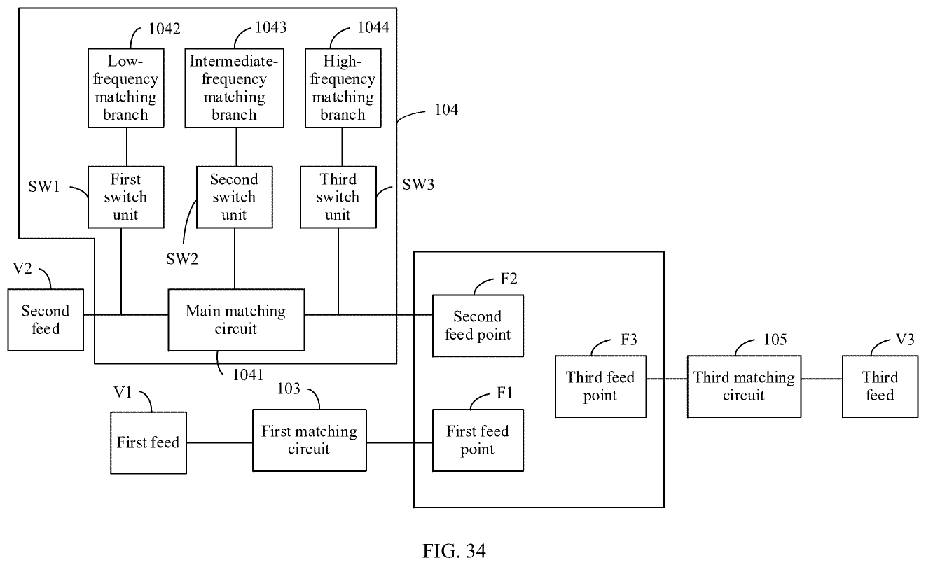

It can be learned from the foregoing analysis that, the first antenna structure A1 can operate well near 2.07 GHz and 2.48 GHz frequency bands under excitation by the first feed V1, which are close to frequency bands of a Wi-Fi signal, a Bluetooth signal, and a GPS signal; and the second conductor 41 can operate well near the frequency of 1.43 GHz under excitation by the second feed V2, which is close to some frequencies of cellular signals. Therefore, in some embodiments, when the wearable device 100 includes the structure in FIG. 9, as shown in FIG. 34, the wearable device 100 further includes a first matching circuit 103, a second matching circuit 104, and a third matching circuit 105. The first matching circuit 103 is connected between the first feed V1 and the first feed point F1. The first matching circuit 103 is configured to adjust a first electrical signal output by the first feed V1, so that a frequency band of the first electromagnetic wave signal generated based on the first electrical signal is a GPS L1 frequency band. The second matching circuit 104 is connected between the second feed V2 and the second feed point F2. The second matching circuit 104 is configured to adjust a second electrical signal output by the second feed V2, so that a frequency band of the second electromagnetic wave signal generated based on the second electrical signal is a cellular frequency band (may be a low frequency band, an intermediate frequency band, and/or a high frequency band). The third matching circuit 105 is connected between the third feed V3 and the third feed point F3. The third matching circuit 105 is configured to adjust a third electrical signal output by the third feed V3, so that a frequency band of the third electromagnetic wave signal generated based on the third electrical signal is a 2.4 GHz Wi-Fi signal or a 2.4 GHz Bluetooth signal (that is, the first electromagnetic wave signal is a Wi-Fi signal or a Bluetooth signal).

The first matching circuit 103 and the third matching circuit 105 may include a capacitor, and/or an inductor, and/or a resistor.

As shown in FIG. 34, in some embodiments, the second matching circuit 104 includes a main matching circuit 1041, a low-frequency matching branch 1042, an intermediate-frequency matching branch 1043, a high-frequency matching branch 1044, a first switch unit SW1, a second switch unit SW2, and a third switch unit SW3. The main matching circuit 1041 is connected between the second feed V2 and the second feed point F2. The low-frequency matching branch 1042 and the first switch unit SW1 are connected in series between the second feed point F2 and a ground. The intermediate-frequency matching branch 1043 and the second switch unit SW2 are connected in series between the second feed point F2 and the ground. The high-frequency matching branch 1044 and the third switch unit SW3 are connected in series between the second feed point F2 and the ground. When the second electrical signal needs to be adjusted so that a frequency band of the second electromagnetic wave signal generated based on the second electrical signal is a low frequency band, the first switch unit SW1 is turned on, and the second switch unit SW2 is disconnected from the third switch unit SW3. When the second electrical signal needs to be adjusted so that a frequency band of the second electromagnetic wave signal generated based on the second electrical signal is an intermediate frequency band, the second switch unit SW2 is turned on, and the first switch unit SW1 is disconnected from the third switch unit SW3. When the second electrical signal needs to be adjusted so that a frequency band of the second electromagnetic wave signal generated based on the second electrical signal is a high frequency band, the third switch unit SW3 is turned on, and the first switch unit SW1 is disconnected from the second switch unit SW2.

The main matching circuit 1041, the low-frequency matching branch 1042, the intermediate-frequency matching branch 1043, and the high-frequency matching branch 1044 each include a capacitor, and/or an inductor, and/or a resistor.

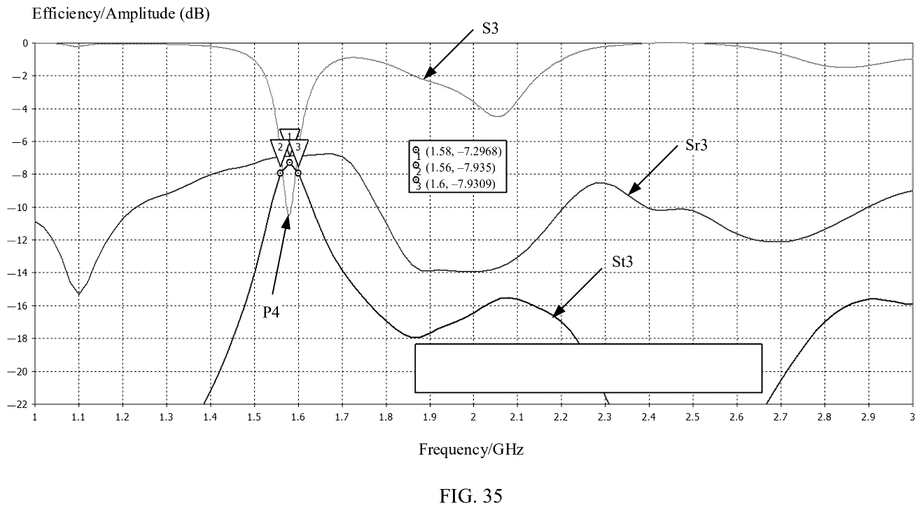

In some embodiments, as shown in FIG. 22, the first feed point F1 is located in a 7 o'clock direction of the wearable device 100, the second feed point F2 is located in a 10 o'clock direction of the wearable device 100, and the third feed point F3 is located in a 2 o'clock direction of the wearable device 100. In this case, FIG. 35 to FIG. 45 are obtained through testing.

FIG. 35 is a simulation diagram of a return loss curve S3, a system radiation efficiency curve Sr3, and a total system efficiency curve St3 present when a first feed V1 excites a first antenna structure A1 via a first matching circuit. It can be learned from FIG. 35 that, the input return loss curve S3 has a minimum point P4, a frequency corresponding to the minimum point P4 is 1.575 GHz, and belongs to the GPS L1 frequency band. Therefore, the first feed V1 may excite the first antenna structure A1 via the first matching circuit to generate a GPS signal.

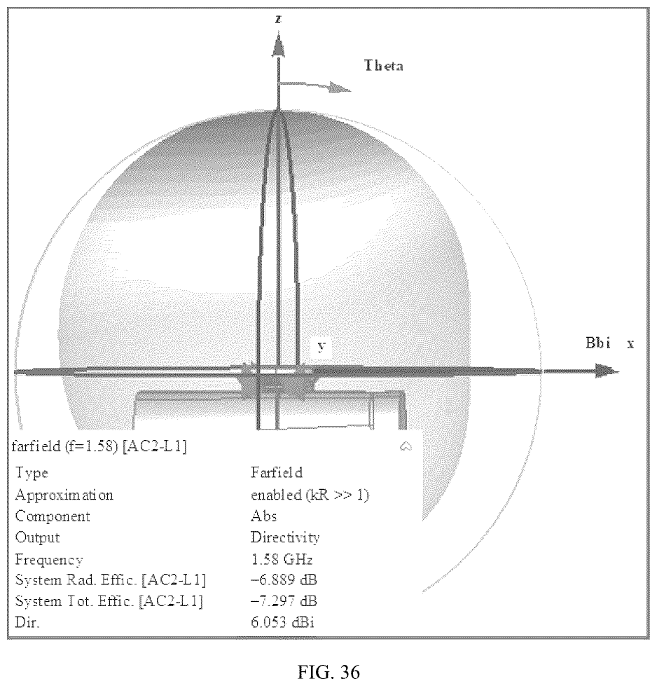

FIG. 36 is an antenna radiation pattern present when the first feed V1 excites the first antenna structure A1 via the first matching circuit to generate the GPS signal. It can be learned from FIG. 36 that, in this way, the first antenna structure A1 has good radiation in a vertical direction. In this case, antenna directivity is 6.053 dBi. This indicates that the first antenna structure A1 has a stronger capability of radiating or receiving a signal in the vertical direction.

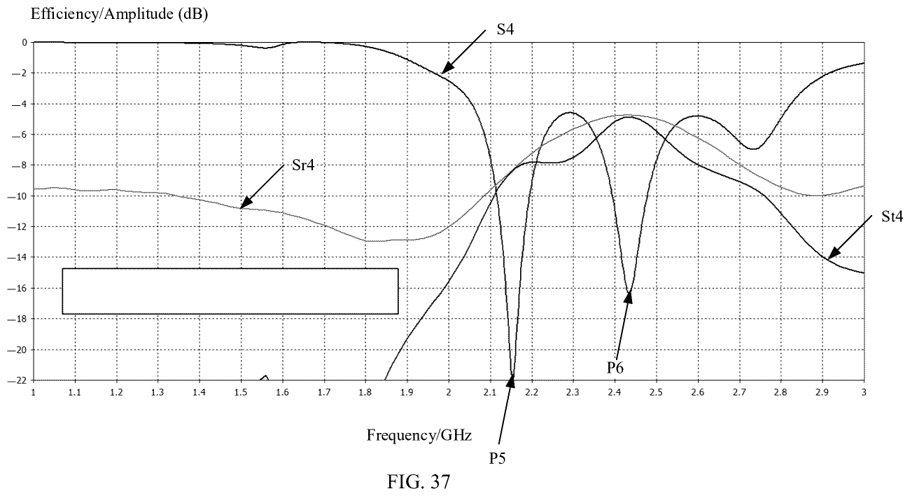

FIG. 37 is a simulation diagram of a return loss curve S4, a system radiation efficiency curve Sr4, and a total system efficiency curve St4 present when the third feed V3 excites the first antenna structure A1 via the third matching circuit to generate a signal. It can be learned from FIG. 37 that, the input return loss curve S4 has two minimum points P5 and P6, a frequency corresponding to the minimum point P5 is 2.15 GHz, and a frequency corresponding to the minimum point P6 is 2.45 GHz.

The system radiation efficiency curve Sr4 of the signal generated by the third feed V3 exciting the first antenna structure A1 via the third matching circuit is higher in a frequency band from 2.15 GHz to 2.45 GHz. The total system efficiency curve St4 of the electromagnetic wave signal generated by the third feed V3 exciting the first antenna structure A1 via the third matching circuit is also higher in the 2.45 GHz frequency band. As a result, the first antenna structure A1 can operate well in a frequency band near 2.45 GHz when excited by the third feed V3 via the third matching circuit, that is, can well operate in a Bluetooth frequency band and a Wi-Fi frequency band (2.4 GHz to 2.483 GHz).

FIG. 38 is an antenna radiation pattern present when the third feed V3 excites the first antenna structure A1 via the third matching circuit to generate a signal. It can be learned from FIG. 38 that, in this case, the first antenna structure A1 has good radiation in the vertical direction, but poor radiation in another direction. In this case, antenna directivity is 5.883 dBi. This indicates that the first antenna structure A1 has a stronger capability of radiating or receiving a signal in the vertical direction.

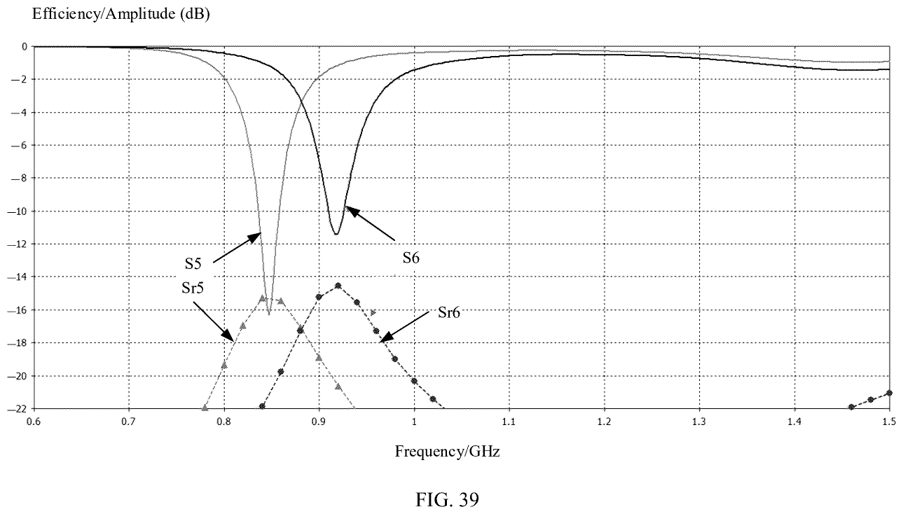

FIG. 39 is a simulation diagram of return loss curves S5 and S6 and efficiency curves Sr5 and Sr6 present when the second feed V2 excites the second conductor 41 via the second matching circuit to generate a signal. It can be learned from FIG. 39 that, in this case, a cellular signal at a low frequency (a B5 frequency band and a B8 frequency band) may be generated through excitation.

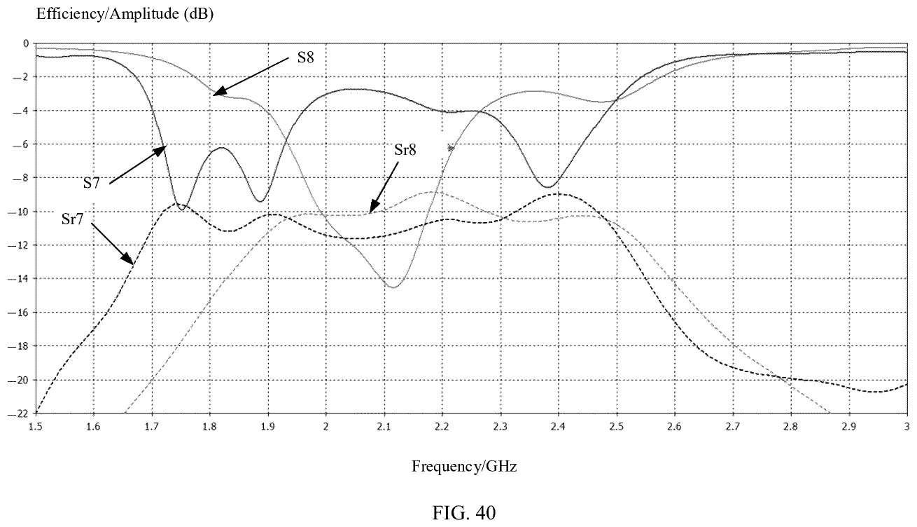

FIG. 40 is a simulation diagram of return loss curves S7 and S8 and efficiency curves Sr7 and Sr8 present when the second feed V2 excites the second conductor 41 via the second matching circuit to generate a signal. It can be learned from FIG. 40 that, in this case, a cellular signal at an intermediate frequency (a B1 frequency band and a B3 frequency band) may be generated through excitation.

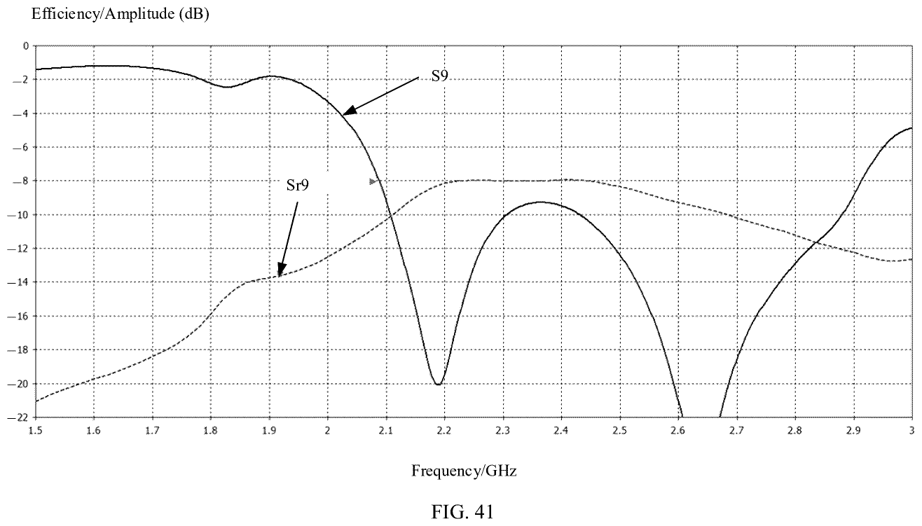

FIG. 41 is a simulation diagram of a return loss curve S9 and an efficiency curve Sr9 present when the second feed V2 excites the second conductor 41 via the second matching circuit to generate a signal. It can be learned from FIG. 41 that, in this case, a cellular signal at a high frequency (a B40 frequency band and a B41 frequency band) may be generated through excitation.

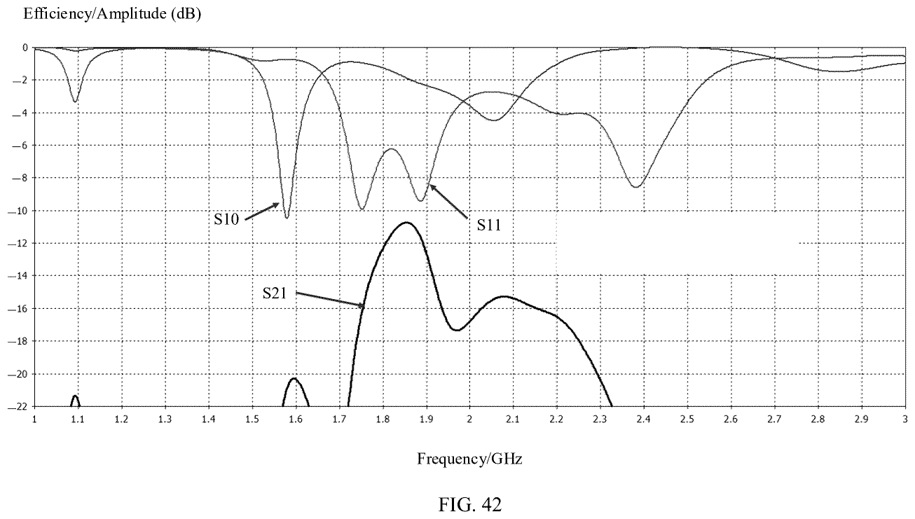

FIG. 42 is a diagram of a second type of return loss curves and an isolation curve of the wearable device 100. FIG. 42 is a diagram of a return loss curve and an isolation curve that are obtained through simulation testing by using an example in which the wearable device 100 including both the first antenna structure A1 and the second conductor 41 in any one of the foregoing embodiments operates in a GPS L1 frequency band and a B3 frequency band.

Specifically, that the wearable device 100 operates in the GPS L1 frequency band may be that the first feed V1 of the wearable device 100 excites the first antenna structure A1 via the first matching circuit to operate in the GPS L1 frequency band. That the wearable device 100 operates in the B3 frequency band may be that the second feed V2 of the wearable device 100 excites the second conductor 41 via the second matching circuit to operate in the B3 frequency band.

FIG. 42 shows a return loss curve S10 of the wearable device 100 operating in the GPS L1 frequency band and a return loss curve S11 of the wearable device 100 operating in the B3 frequency band, and reflects an isolation curve S21 between the GPS L1 frequency band and the B3 frequency band.

When an absolute value of isolation corresponding to the isolation curve S21 is lower, the isolation is poorer. When an absolute value of isolation corresponding to the isolation curve S21 is higher, the isolation is better. It can be learned from FIG. 42 that, an isolation value corresponding to a resonance frequency of 1.75 GHz in the B3 frequency band is appropriately 16 dB, and an isolation value corresponding to a resonance frequency of 1.575 GHz in the GPS L1 frequency band is appropriately −20 dB. Therefore, it can be learned that, isolation between the GPS L1 frequency band and the B3 frequency band is excellent. During simultaneous operation in the two frequency bands, mutual interference is small.

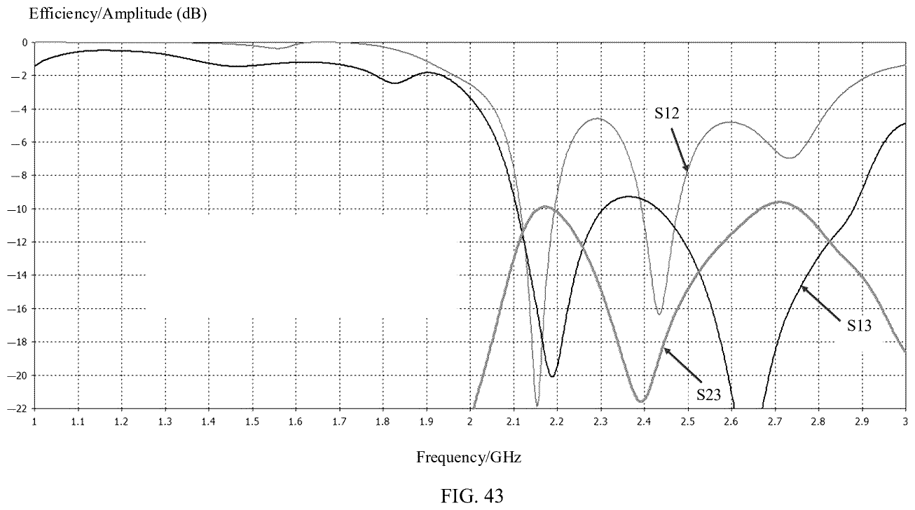

FIG. 43 is a diagram of a third type of return loss curve and an isolation curve of the wearable device 100. Specifically, FIG. 43 is a simulation diagram of a return loss curve S12 of a 2.4 GHz Bluetooth signal generated by the third feed V3 exciting the first antenna structure A1 via the third matching circuit, a return loss curve S13 of a cellular signal in a B41 frequency band generated by the second feed V2 exciting the second conductor 41 via the second matching circuit, and an isolation curve S23. It can be learned from FIG. 43 that, when the third feed V3 excites, via the third matching circuit, the first antenna structure A1 to operate in a 2.4 GHz frequency band, isolation is appropriately −18 dB; when the second feed V2 excites, via the second matching circuit, the second conductor 41 to operate in the B41 frequency band (2.496 GHz to 2.69 GHz), isolation is appropriately −13 dB to −10 dB. Therefore, isolation between the 2.4 GHz frequency band and the B41 frequency band is good, thereby allowing for simultaneous operation in the two frequency bands.

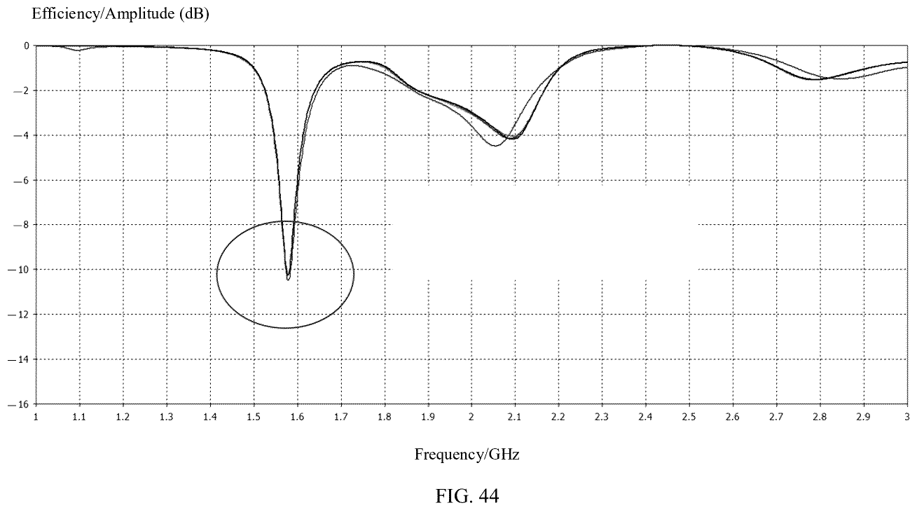

FIG. 44 is a simulation diagram of a return loss curve of the first feed V1 exciting the first antenna structure A1 via the first matching circuit to generate a GPS signal, when the second feed V2 switches between cellular signals in different frequency bands via the second matching circuit. It can be learned from FIG. 44 that, switching between different cellular frequency bands has little impact on GPS signals.

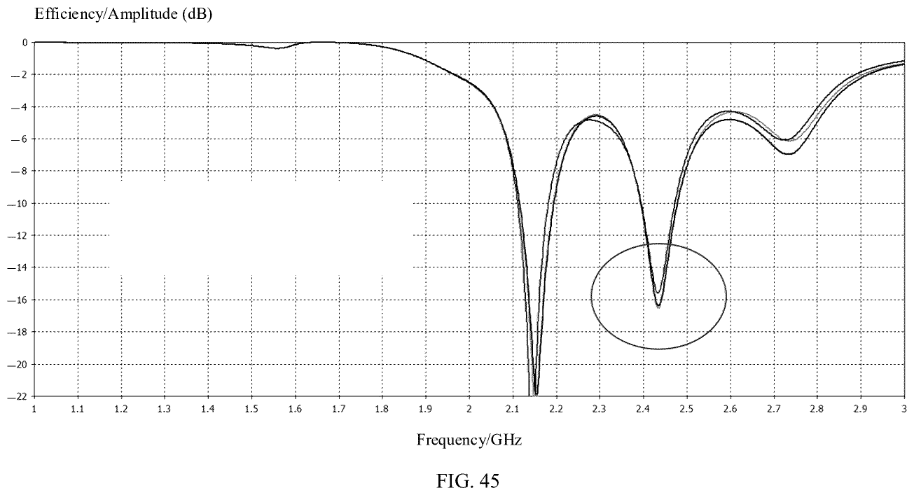

FIG. 45 is a simulation diagram of a return loss curve of a Bluetooth signal generated by the third feed V3 exciting the first antenna structure A1 via the third matching circuit when the second feed V2 switches between cellular signals in different frequency bands via the second matching circuit. It can be learned from FIG. 45 that, switching between different cellular frequency bands has little impact on the Bluetooth signal.

In this way, the first feed point F1 is located in a 2 o'clock direction of the wearable device 100 and generates a GPS signal, the second feed point F2 is located in a 10 o'clock direction of the wearable device 100 and generates a cellular signal, and the third feed point F3 is located in a 3 o'clock direction of the wearable device 100 and generates a Bluetooth signal, implementing good effect.

In another embodiment, positions of the first feed point F1, the second feed point F2, and the third feed point F3 may be other positions. This is not limited herein. The first feed V1 may excite the first antenna structure A1 via the first matching circuit to generate a GPS signal.

The first feed point F1, the third feed point F3, and the fifth feed point F5 may be mutually adaptively replaced. It is implied herein that during replacement, the first feed point F1 and the first feed V1 are integrated, the third feed point F3 and the third feed V3 are integrated, and the fifth feed point F5 and the fifth feed V5 are integrated.

Similarly, the second feed point F2 and the fourth feed point F4 may also be mutually replaced. Similarly, it is also implied herein that during replacement, the second feed point F2 and the second feed V2 are integrated, and the fourth feed point F4 and the fourth feed V4 are integrated.

In descriptions of this application, unless otherwise expressly specified and limited, the term “connect” should be understood in a broad sense. For example, such a term may indicate a fixed connection, a detachable connection, or an integral connection; may indicate direct interconnection, indirect interconnection through an intermediate medium, or an internal communication between two elements; and may indicate a communication connection, or an electrical connection. For a person of ordinary skill in the art, a specific meaning of the foregoing terms in this application may be understood based on a specific situation.

In descriptions of this application, the terms “first”, “second”, “third”, and the like are intended to distinguish between different objects but do not indicate a particular order. In addition, orientation or position relationships indicated by terms “above”, “below”, “inner”, “outer”, and the like are orientation or position relationships based on the accompanying drawings, and are merely intended for ease of describing this application and simplifying description, rather than indicating or implying that an apparatus or element in question needs to have a specific orientation or needs to be constructed and operated in a specific orientation. Therefore, such terms cannot be construed as a limitation on this application.

In the foregoing embodiments, descriptions of embodiments have respective focuses. For a part that is not described in detail in an embodiment, refer to related descriptions in other embodiments.

An “embodiment” mentioned in this specification means that a particular feature, structure, or characteristic described with reference to this embodiment may be included in at least one embodiment of the present invention. The phrase shown in various locations in this specification may not necessarily mean a same embodiment, and is not an independent or optional embodiment exclusive from another embodiment. It is explicitly and implicitly understood by a person skilled in the art that embodiments described in this specification may be combined with another embodiment.

The above are only the implementations of embodiments of this application, and it should be noted that for a person of ordinary skill in the art, several improvements and modifications may be made without departing from the principle of embodiments of this application, and these improvements and modifications are also regarded as falling within the protection scope of this application.

What is claimed is:

1. A wearable device, wherein the wearable device comprises:
a display;
a bottom housing, comprising a first conductor, wherein the first conductor comprises a first feed point;
a first circuit board, located between the first conductor and the display, wherein the first circuit board comprises a first conductor layer; and
a first feed, disposed on the first circuit board, wherein the first feed is electrically connected to the first feed point; and
the first conductor is spaced apart from the first circuit board, the first feed is configured to excite a first antenna structure through the first feed point to generate a first electromagnetic wave signal, and the first antenna structure comprises at least the first conductor and the first conductor layer of the first circuit board.

2. The wearable device according to claim 1, wherein at least a part of the first conductor is parallel to the first circuit board.

3. The wearable device according to claim 1, wherein the first antenna structure is a cavity antenna structure or a patch antenna structure.

4. The wearable device according to claim 3, wherein a resonance frequency of the first antenna structure is determined based on at least a length of a long side and/or a length of a short side of the first conductor.

5. The wearable device according to claim 1, wherein the wearable device further comprises a second feed and a side frame, and the side frame comprises a second conductor;
the second conductor comprises a second feed point, the side frame is disposed between the display and the bottom housing, and there is a gap between the second conductor and the first conductor; and
the second feed is electrically connected to the second feed point, and the second feed is configured to excite the second conductor through the second feed point to generate a second electromagnetic wave signal.

6. The wearable device according to claim 5, wherein the gap between the second conductor and the first conductor is used for at least the first electromagnetic wave signal to radiate outward from the wearable device.

7. The wearable device according to claim 6, wherein the first conductor is partially electrically connected to the first conductor layer of the first circuit board.

8. The wearable device according to claim 6, wherein the first conductor is partially electrically connected to the second conductor.

9. The wearable device according to claim 1, wherein the bottom housing further comprises a bottom housing body; and
the first conductor is a metal sheet disposed in the bottom housing body; or
the first conductor is a metal layer formed on an inner surface and/or an outer surface of the bottom housing body through a preparation process.

10. The wearable device according to claim 1, wherein the first feed point is provided in an edge region or a middle region of the first conductor.

11. The wearable device according to claim 5, wherein the wearable device further comprises a third feed, the third feed is disposed on the first circuit board, the first conductor further comprises a third feed point, the third feed point is spaced apart from the first feed point, and the third feed is connected to the third feed point and is configured to excite the first antenna structure through the third feed point to generate a third electromagnetic wave signal.

12. The wearable device according to claim 5, wherein the second feed is disposed on the first circuit board.

13. The wearable device according to claim 12, wherein an edge part that is of the first conductor layer of the first circuit board and that is close to the first feed point is electrically connected to the second conductor.

14. The wearable device according to claim 12, wherein the wearable device further comprises a fourth feed, the second conductor further comprises a fourth feed point, the fourth feed point is spaced apart from the second feed point, the fourth feed is disposed on the first circuit board and is connected to the fourth feed point, and the fourth feed excites the second conductor through the fourth feed point to generate a fourth electromagnetic wave signal.

15. The wearable device according to claim 5, wherein the wearable device further comprises a second circuit board;
the second circuit board is disposed between the first circuit board and the display; and
the second feed is disposed on the first circuit board or the second circuit board.

16. The wearable device according to claim 15, wherein the second feed is disposed on the first circuit board, the wearable device further comprises a fourth feed, the second conductor further comprises a fourth feed point, the fourth feed is disposed on the second circuit board and is connected to the fourth feed point, and the fourth feed excites the second conductor through the fourth feed point to generate a fourth electromagnetic wave signal.

17. The wearable device according to claim 15, wherein the wearable device further comprises a fourth feed, the second conductor further comprises a fourth feed point, the fourth feed is connected to the fourth feed point and is configured to excite the second conductor through the fourth feed point to generate a fourth electromagnetic wave signal, and both the second feed and the fourth feed are disposed on the second circuit board.

18. The wearable device according to claim 17, wherein the wearable device further comprises a third conductor; the third conductor is disposed between the first circuit board and the second circuit board, and is spaced apart from the first circuit board and the second circuit board; a periphery of the third conductor is connected to an inner surface of the second conductor, or a periphery of the third conductor is spaced apart from an inner surface of the second conductor and the spacing is less than or equal to a preset distance; and the third conductor is configured to at least isolate an electromagnetic wave signal generated through excitation by a feed disposed on the first circuit board and an electromagnetic wave signal generated through excitation by a feed disposed on the second circuit board from each other.

19. The wearable device according to claim 5, wherein positions of projections of the first feed point and the second feed point on the first circuit board are the same or different; the first electromagnetic wave signal and the second electromagnetic wave signal are signals among Wi-Fi signals, Bluetooth signals, GPS signals, and cellular signals; and the first electromagnetic wave signal and the second electromagnetic wave signal are the same or different.

20. The wearable device according to claim 11, wherein positions of projections of the first feed point, the second feed point, and the third feed point on the first circuit board are different; connection lines between a center of the first circuit board and the positions of the projections of the first feed point, the second feed point, and the third feed point on the first circuit board are on different radial lines; the first electromagnetic wave signal, the second electromagnetic wave signal, and the third electromagnetic wave signal are signals among Wi-Fi signals, Bluetooth signals, GPS signals, and cellular signals; and the first electromagnetic wave signal, the second electromagnetic wave signal, and the third electromagnetic wave signal are the same, or at least one of the first electromagnetic wave signal, the second electromagnetic wave signal, and the third electromagnetic wave signal is different.
